(19) United States
(12) Patent Application Publication
(10) Pub. No.: US 2025/0364777 A1
(43) Pub. Date: Nov. 27, 2025

(54) DISCHARGE EXCITATION LASER APPARATUS, DISCHARGE EXCITATION LASER APPARATUS CONTROL METHOD, AND ELECTRONIC DEVICE MANUFACTURING METHOD

(71) Applicant: Gigaphoton Inc., Oyama-shi (JP)

(72) Inventors: Tomonari TANAKA, Oyama-shi (JP); Osamu WAKABAYASHI, Oyama-shi (JP)

(73) Assignee: Gigaphoton Inc., Oyama-shi (JP)

(21) Appl. No.: 19/292,641

(22) Filed: Aug. 6, 2025

Related U.S. Application Data
(63) Continuation of application No. PCT/JP2023/008536, filed on Mar. 7, 2023.

(51) Int. Cl. H01S 3/139; H01S 3/034; H01S 3/08

(52) U.S. Cl. CPC H01S 3/139; H01S 3/034; H01S 3/08059

(57) ABSTRACT

A discharge excitation laser apparatus includes a laser chamber including a pair of discharge electrodes disposed therein, an optical resonator including cylindrical convex and concave mirrors and configured to form an off-axis optical path along a first plane parallel to a discharge direction of discharge between the discharge electrodes and a longitudinal direction of the discharge electrodes intersecting the discharge direction, a mirror stage including a first actuator configured to move the cylindrical convex mirror in the discharge direction and a second actuator configured to rotate the cylindrical convex mirror about an axis intersecting the first plane, a beam characteristic measuring device configured to measure a beam characteristic of a laser beam, and a processor configured to control the first and second actuators to increase an oscillation region of the laser beam on the basis of an evaluation parameter related to the oscillation region obtained from the beam characteristic.

### CROSS-REFERENCE TO RELATED APPLICATIONS

The present application is a continuation application of International Application No. PCT/JP2023/008536, filed on Mar. 7, 2023, the entire contents of which are hereby incorporated by reference.

### BACKGROUND

### 1. Technical Field

The present disclosure relates to a discharge excitation laser apparatus, a discharge excitation laser apparatus control method, and an electronic device manufacturing method.

### 2. Related Art

Recently, an improvement in resolutions of semiconductor exposure apparatuses has been desired with miniaturization and high integration of semiconductor integrated circuits. For this purpose, exposure light sources that release light having a shorter wavelength have been developed. Examples of a gas laser apparatus for exposure include a KrF excimer laser apparatus configured to output a laser beam having a wavelength of about 248 nm and an ArF excimer laser apparatus configured to output a laser beam having a wavelength of about 193 nm.

### LIST OF DOCUMENTS

### Patent Documents

Patent Document 1: Japanese Unexamined Patent Application Publication No. 2004-039767
Patent Document 2: U.S. Unexamined Patent Application Publication No. 2018/0109065
Patent Document 3: U.S. Unexamined Patent Application Publication No. 2007/0091968
Patent Document 4: Japanese Unexamined Patent Application Publication No. 09-214023
Patent Document 5: U.S. Unexamined Patent Application Publication No. 2011/0163077

### SUMMARY

In one aspect of the present disclosure, a discharge excitation laser apparatus includes a laser chamber that includes a pair of discharge electrodes disposed therein, an optical resonator that includes a cylindrical convex mirror and a cylindrical concave mirror and is configured to form an off-axis optical path along a first plane that is parallel to a discharge direction of discharge between the discharge electrodes and a longitudinal direction of the discharge electrodes intersecting the discharge direction, a mirror stage that includes a first actuator configured to move the cylindrical convex mirror in the discharge direction and a second actuator configured to rotate the cylindrical convex mirror in an axis intersecting the first plane, a beam characteristic measuring device configured to measure a beam characteristic of a laser beam output from the optical resonator, and a processor configured to control the first and second actuators to increase an oscillation region of the laser beam on the basis of an evaluation parameter value related to the oscillation region obtained from the beam characteristic.

In another aspect of the present disclosure, a discharge excitation laser apparatus control method of a discharge excitation laser apparatus including a laser chamber that includes a pair of discharge electrodes disposed therein, an optical resonator that includes a cylindrical convex mirror and a cylindrical concave mirror and is configured to form an off-axis optical path along a first plane that is parallel to a discharge direction of discharge between the discharge electrodes and a longitudinal direction of the discharge electrodes intersecting the discharge direction, a mirror stage that includes a first actuator configured to move the cylindrical convex mirror in the discharge direction and a second actuator configured to rotate the cylindrical convex mirror about an axis intersecting the first plane, and a beam characteristic measuring device configured to measure a beam characteristic of a laser beam output from the optical resonator includes measuring the beam characteristic by the beam characteristic measuring device, and controlling the first and second actuators to increase an oscillation region of the laser beam on the basis of an evaluation parameter value related to the oscillation region obtained from the beam characteristic.

In another aspect of the present disclosure, an electronic device manufacturing method includes creating an interposer by laser-processing an interposer substrate with a discharge excitation laser apparatus including a laser chamber that includes a pair of discharge electrodes disposed therein, an optical resonator that includes a cylindrical convex mirror and a cylindrical concave mirror and is configured to form an off-axis optical path along a first surface that is parallel to a discharge direction of discharge between the discharge electrodes and a longitudinal direction of the discharge electrodes intersecting the discharge direction, a mirror stage that includes a first actuator configured to move the cylindrical convex mirror in the discharge direction and a second actuator configured to rotate the cylindrical convex mirror about an axis intersecting the first plane, a beam characteristic measuring device configured to measure a beam characteristic of a laser beam output from the optical resonator, and a processor configured to control the first and second actuators to increase an oscillation region of a laser beam on the basis of an evaluation parameter value related to the oscillation region obtained from the beam characteristic, coupling and electrically connecting the interposer and an integrated circuit chip to each other, and coupling and electrically connecting the interposer and a circuit substrate to each other.

### BRIEF DESCRIPTION OF THE DRAWINGS

Some embodiments of the present disclosure will be described below, by way of example only, with reference to the accompanying drawings.

FIG. 1 schematically illustrates a configuration of a laser processing system in a comparative example.

FIG. 2 illustrates arrangement of a rear mirror, a front mirror, and discharge electrodes.

FIG. 3 illustrates arrangement of the rear mirror, the front mirror, and the discharge electrodes.

FIG. 4 illustrates a positional relationship of the rear mirror, the front mirror, and the discharge electrodes.

FIG. 5 illustrates a positional relationship of the rear mirror, the front mirror, and the discharge electrodes.

FIG. 6 illustrates another example of the positional relationship of the rear mirror, the front mirror, and the discharge electrodes.

FIG. 7 illustrates yet another example of the positional relationship of the rear mirror, the front mirror, and the discharge electrodes.

FIG. 8 is a grayscale photograph showing, by brightness/darkness, light intensity distribution of a pulse laser beam output from an optical resonator in a comparative example.

FIG. 9 schematically illustrates a designed optical path of the optical resonator in a comparative example.

FIG. 10 schematically illustrates arrangement of an optical resonator in a first embodiment.

FIG. 11 is a grayscale photograph showing, by brightness/darkness, light intensity distribution of a pulse laser beam output from an optical resonator in a comparative example.

FIG. 12 is a graph showing a pulse time waveform of the pulse laser beam output from the optical resonator in the comparative example.

FIG. 13 is a grayscale photograph showing, by brightness/darkness, light intensity distribution of a pulse laser beam output from the optical resonator in a case where the amount of protrusion is set to a first value in the first embodiment.

FIG. 14 is a graph showing a pulse time waveform of the pulse laser beam output from the optical resonator in the case where the amount of protrusion is set to the first value.

FIG. 15 is a grayscale photograph showing, by brightness/darkness, light intensity distribution of a pulse laser beam output from the optical resonator in a case where the amount of protrusion is set to a second value in the first embodiment.

FIG. 16 is a graph showing a pulse time waveform of the pulse laser beam output from the optical resonator in the case where the amount of protrusion is set to the second value.

FIG. 17 schematically illustrates a configuration of a laser processing system in the first embodiment.

FIG. 18 illustrates an image of a beam section acquired by a beam characteristic measuring device, along with its light intensity distribution in a V direction and an H direction.

FIG. 19 illustrates a configuration of a front mirror stage as seen in a −V direction.

FIG. 20 illustrates the configuration of the front mirror stage as seen in a −H direction.

FIG. 21 illustrates the configuration of the front mirror stage as seen in a −Z direction.

FIG. 22 illustrates a configuration of a rear mirror stage as seen in the −V direction.

FIG. 23 illustrates the configuration of the rear mirror stage as seen in the −H direction.

FIG. 24 illustrates the configuration of the rear mirror stage as seen in a Z direction.

FIG. 25 is a flowchart illustrating an operation of alignment in the first embodiment.

FIG. 26 is a flowchart illustrating details of processing of initial alignment in the first embodiment.

FIG. 27 is a flowchart illustrating details of processing of oscillation region adjustment in the first embodiment.

FIG. 28 is a flowchart illustrating details of a first example of oscillation region adjustment in the first embodiment.

FIG. 29 is a flowchart illustrating details of a second example of oscillation region adjustment in the first embodiment.

FIG. 30 is a flowchart illustrating details of processing to obtain an optimal value of the amount of protrusion in the first embodiment.

FIG. 31 illustrates an example of an approximate curve obtained in FIG. 30.

FIG. 32 schematically illustrates a configuration of a laser processing system in a second embodiment.

FIG. 33 is a graph showing a pulse time waveform in each of an oscillation region and an ASE region of a pulse laser beam.

FIG. 34 is a flowchart illustrating details of processing of oscillation region adjustment in the second embodiment.

FIG. 35 is a flowchart illustrating details of a first example of oscillation region adjustment in the second embodiment.

FIG. 36 is a flowchart illustrating details of a second example of oscillation region adjustment in the second embodiment.

FIG. 37 is a flowchart illustrating details of processing to obtain an optimal value of the amount of protrusion in the second embodiment.

FIG. 38 illustrates an example of an approximate curve obtained in FIG. 37.

FIG. 39 is a flowchart illustrating details of a third example of oscillation region adjustment in the second embodiment.

FIG. 40 is a flowchart illustrating details of processing to obtain an optimal value of the amount of protrusion from a plurality of evaluation parameter values in the second embodiment.

FIG. 41 illustrates examples of two approximate curves obtained in FIG. 40.

FIG. 42 schematically illustrates a configuration of a laser processing system in a third embodiment.

FIG. 43 is an optical resonator and a laser chamber in the third embodiment as seen in the −V direction.

FIG. 44 is a flowchart illustrating details of processing of oscillation region adjustment in the third embodiment.

FIG. 45 is a flowchart illustrating details of a first example of oscillation region adjustment in the third embodiment.

FIG. 46 is a flowchart illustrating details of a second example of oscillation region adjustment in the third embodiment.

FIG. 47 is a flowchart illustrating details of processing to obtain an optimal value of the amount of protrusion in the third embodiment.

FIG. 48 illustrates an example of an approximate curve obtained in FIG. 47.

FIG. 49 schematically illustrates a configuration of a laser processing system in a fourth embodiment.

FIG. 50 illustrates an image of a focused beam section acquired by a beam divergence measuring device, along with its light intensity distribution in a V direction and an H direction.

FIG. 51 is a flowchart illustrating details of processing of initial alignment in the fourth embodiment.

FIG. 52 is a flowchart illustrating details of processing of oscillation region adjustment in the fourth embodiment.

FIG. 53 is a flowchart illustrating details of a first example of oscillation region adjustment in the fourth embodiment.

FIG. 54 is a flowchart illustrating details of a second example of oscillation region adjustment in the fourth embodiment.

FIG. 55 is a flowchart illustrating details of processing to obtain an optimal value of the amount of protrusion in the second example of the fourth embodiment.

FIG. 56 illustrates an example of an approximate curve obtained in FIG. 55.

FIG. 57 is a flowchart illustrating details of a third example of oscillation region adjustment in the fourth embodiment.

FIG. 58 is a flowchart illustrating details of a fourth example of oscillation region adjustment in the fourth embodiment.

FIG. 59 is a flowchart illustrating details of processing to obtain an optimal value of amount of protrusion in the fourth example of the fourth embodiment.

FIG. 60 illustrates an example of an approximate curve obtained in FIG. 59.

FIG. 61 schematically illustrates a configuration of a laser processing system in a fifth embodiment.

FIG. 62 is a flowchart illustrating details of processing of oscillation region adjustment in the fifth embodiment.

FIG. 63 is a flowchart illustrating details of a first example of oscillation region adjustment in the fifth embodiment.

FIG. 64 is a flowchart illustrating details of a second example of oscillation region adjustment in the fifth embodiment.

FIG. 65 is a flowchart illustrating details of processing to obtain an optimal value of the amount of protrusion in the fifth embodiment.

FIG. 66 illustrates an example of an approximate curve obtained in FIG. 65.

FIG. 67 is a flowchart illustrating details of a third example of oscillation region adjustment in the fifth embodiment.

FIG. 68 is a flowchart illustrating details of processing to obtain an optimal value of the amount of protrusion from a plurality of evaluation parameter values in the fifth embodiment.

FIG. 69 illustrates examples of two approximate curves obtained in FIG. 68.

FIG. 70 schematically illustrates a configuration of an electronic device.

FIG. 71 is a flowchart illustrating an electronic device manufacturing method.

### DESCRIPTION OF EMBODIMENTS

### <Contents>

1. Laser Processing System According to Comparative Example
   1.1 Configuration
   1.2 Operation
   1.3 Reference Axis of Discharge Space
   1.4 Problem in Comparative Example
2. Laser Apparatus 1a for Adjusting Position of Front Mirror 15
   2.1 Basic Concept
   2.2 Configuration
   2.3 Operation
      2.3.1 Main Flow
      2.3.2 Operation of Initial Alignment
      2.3.3 Operation of Oscillation Region Adjustment
         2.3.3.1 Oscillation Region Adjustment to Search for Maximum Value of Evaluation Parameter Value
         2.3.3.2 Oscillation Region Adjustment to Acquire Relationship of Amount X of Protrusion and Evaluation Parameter Value
   2.4 Effect
3. Laser Apparatus 1b Using Pulse Time Width ΔT as Evaluation Parameter Value
   3.1 Configuration
   3.2 Operation of Oscillation Region Adjustment
      3.2.1 Oscillation Region Adjustment to Search for Maximum Value of Evaluation Parameter Value
      3.2.2 Oscillation Region Adjustment to Acquire Relationship of Amount X of Protrusion and Evaluation Parameter Value
      3.2.3 Oscillation Region Adjustment to Acquire Relationship of Amount X of Protrusion and Plurality of Evaluation Parameter Values
   3.3 Effect
4. Laser Apparatus 1c Using Result of Measuring Polarization as Evaluation Parameter Value
   4.1 Configuration
   4.2 Operation of Oscillation Region Adjustment
      4.2.1 Oscillation Region Adjustment to Search for Maximum Value of Evaluation Parameter Value
      4.2.2 Oscillation Region Adjustment to Acquire Relationship of Amount X of Protrusion and Evaluation Parameter Value
   4.3 Effect
5. Laser Apparatus 1d Using Result of Measurement by Beam Divergence Measuring Device 20 as Evaluation Parameter Value
   5.1 Configuration
   5.2 Operation of Initial Alignment
   5.3 Operation of Oscillation Region Adjustment
      5.3.1 Oscillation Region Adjustment to Search for Maximum Value of Evaluation Parameter Value
      5.3.2 Oscillation Region Adjustment to Acquire Relationship of Amount X of Protrusion and Evaluation Parameter Value
      5.3.3 Oscillation Region Adjustment to Search for Minimum Value of Beam Divergence BDV
      5.3.4 Oscillation Region Adjustment to Acquire Relationship of Amount X of Protrusion and Beam Divergence BDV
   5.4 Effect
6. Laser Apparatus 1f Using Partial Beam Characteristic as Evaluation Parameter Value
   6.1 Configuration
   6.2 Operation of Oscillation Region Adjustment
      6.2.1 Oscillation Region Adjustment to Search for Maximum Value of Evaluation Parameter Value
      6.2.2 Oscillation Region Adjustment to Acquire Relationship of Amount X of Protrusion and Evaluation Parameter Value
      6.2.3 Oscillation Region Adjustment to Acquire Relationship of Amount X of Protrusion and Plurality of Evaluation Parameter Values
   6.3 Effect
7. Others
   7.1 Electronic Device Including Interposer IP
   7.2 Supplement

Embodiments of the present disclosure will be described below in detail with reference to the accompanying drawings. The embodiments described below are some examples of the present disclosure, and do not limit the contents of the present disclosure. In addition, all configurations and operations described in the embodiments are not necessarily essential as configurations and operations of the present disclosure. Here, the same components will be denoted by the same reference numerals, and redundant description thereof will be omitted.

### 1. Laser Processing System According to Comparative Example

### 1.1 Configuration

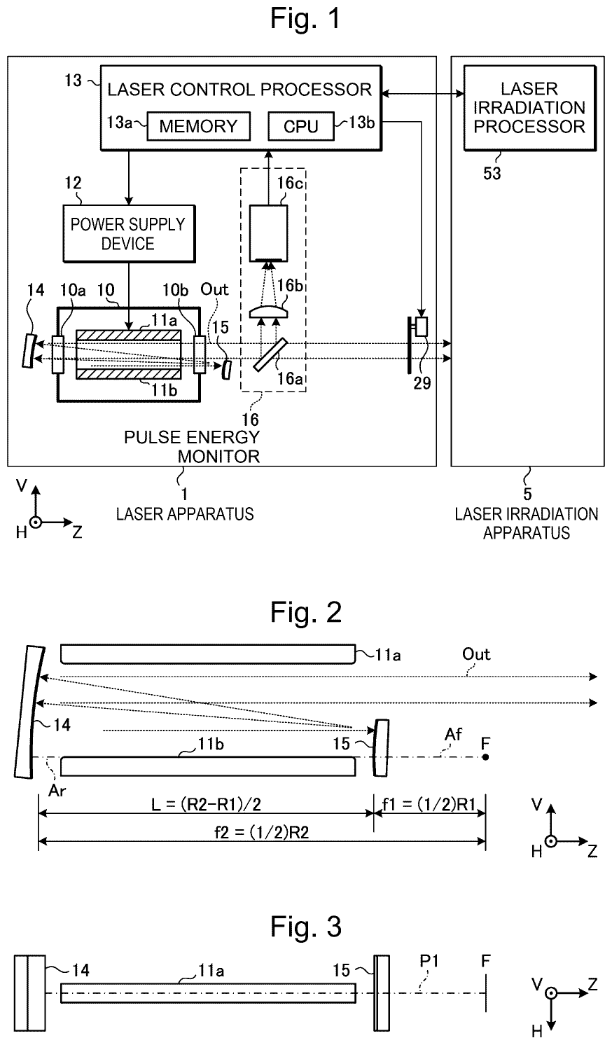

FIG. 1 schematically illustrates a configuration of a laser processing system in a comparative example. The comparative example of the present disclosure is an example recognized by the applicant as known only by the applicant, and is not a publicly known example admitted by the applicant. In FIG. 1, a V axis, a Z axis, and an H axis that are orthogonal to one another are illustrated. The laser processing system includes a laser apparatus 1 and a laser irradiation apparatus 5.

The laser apparatus 1 is discharge excitation laser apparatus that outputs an ultraviolet pulse laser beam Out. The laser apparatus 1 includes a laser chamber 10, a pair of discharge electrodes 11a and 11b, a power supply device 12, a laser control processor 13, a rear mirror 14, a front mirror 15, a pulse energy monitor 16, and a shutter 29. The rear mirror 14 and the front mirror 15 configure an optical resonator.

FIGS. 2 and 3 illustrate arrangement of the rear mirror 14, the front mirror 15, and the discharge electrodes 11a and 11b. FIG. 2 corresponds to the arrangement as seen in the −H direction, and FIG. 3 corresponds to the arrangement as seen in the −V direction. The rear mirror 14 is configured of a cylindrical concave mirror, and the front mirror 15 is configured of a cylindrical convex mirror. The focal length f2 of the rear mirror 14 is half the radius of curvature R2 of the rear mirror 14, and the focal length f1 of the front mirror 15 is half the radius of curvature R1 of the front mirror 15. In order to allow light to reciprocate between the rear mirror 14 and the front mirror 15 for laser oscillation, the rear mirror 14 and front mirror 15 are arranged such that their focal axes F substantially coincide with each other. As a result, the resonator length L is half a difference (R2−R1) between the radii of curvature R1 and R2. In one example, the resonator length L is 1006 mm, the radius of curvature R1 is 288 mm, and the radius of curvature R2 is 2300 mm. The focal axis F is parallel to the H axis.

In the present disclosure, a line that is a normal to a reflective surface of the rear mirror 14 and intersects the focal axis F is defined as an optical axis Ar of the rear mirror 14, and a line that is a normal to a reflective surface of the front mirror 15 and intersects the focal axis F is defined as an optical axis Af of the front mirror 15. The rear mirror 14 and the front mirror 15 are arranged such that their optical axes Ar and Af substantially coincide with each other, and the coincident optical axes Ar and Af are regarded as an optical axis of the optical resonator.

A discharge direction of discharge between the discharge electrodes 11a and 11b is parallel to the V axis, and a longitudinal direction of the discharge electrodes 11a and 11b is parallel to the Z axis. A plane that is parallel to both the discharge direction and the longitudinal direction, that is, parallel to a VZ plane and that passes through the discharge electrodes 11a and 11b is defined as a first plane P1. An optical path of light that reciprocates between the rear mirror 14 and the front mirror 15 becomes an off-axis optical path that diverges from the optical axes Ar and Af while expanding along the first plane P1. The off-axis optical path reaches a side further outward than an outer edge of the front mirror 15, and a pulse laser beam Out is output from the optical resonator. The optical resonator that forms such an off-axis optical path is referred to as an off-axis unstable resonator. However, since the rear mirror 14 and the front mirror 15 are configured of cylindrical mirrors, the optical path within the optical resonator does not diverge in a direction parallel to the H axis although it diverges in a direction parallel to the V axis. Therefore, this optical resonator is an unstable resonator in the V direction while the optical resonator is a stable resonator in the H direction. A pulse laser beam output from the stable resonator including a plane mirror as a rear mirror and a partially reflective plane mirror as a front mirror has a large Me value, while it is possible to reduce the Me value and to improve beam quality by using an unstable resonator in principle.

Referring again to FIG. 1, the laser chamber 10 is disposed in an optical path of the optical resonator. The laser chamber 10 is provided with windows 10a and 10b. The discharge electrodes 11a and 11b are disposed inside the laser chamber 10, and laser gas containing a laser medium component is also accommodated therein. The laser medium is, for example, F₂, ArF, KrF, XeCl, or XeF.

The pulse energy monitor 16 includes a beam splitter 16a, a light condensing optical system 16b, and a photosensor 16c. The beam splitter 16a is located on the optical path of the pulse laser beam Out output from the optical resonator. The light condensing optical system 16b condenses the pulse laser beam Out reflected by the beam splitter 16a. The photosensor 16c is located on the optical path of the pulse laser beam Out that has passed through the light condensing optical system 16b.

The shutter 29 is located on the optical path of the pulse laser beam Out having been transmitted through the beam splitter 16a. The shutter 29 is configured to be able to switch passing and blocking of the pulse laser beam Out to the laser irradiation apparatus 5.

The laser control processor 13 is a processing device including a memory 13a that stores a control program and a central processing unit (CPU) 13b that executes the control program. The laser control processor 13 corresponds to the processor in the present disclosure. The laser control processor 13 is specifically configured or programmed to execute various kinds of processing included in the present disclosure.

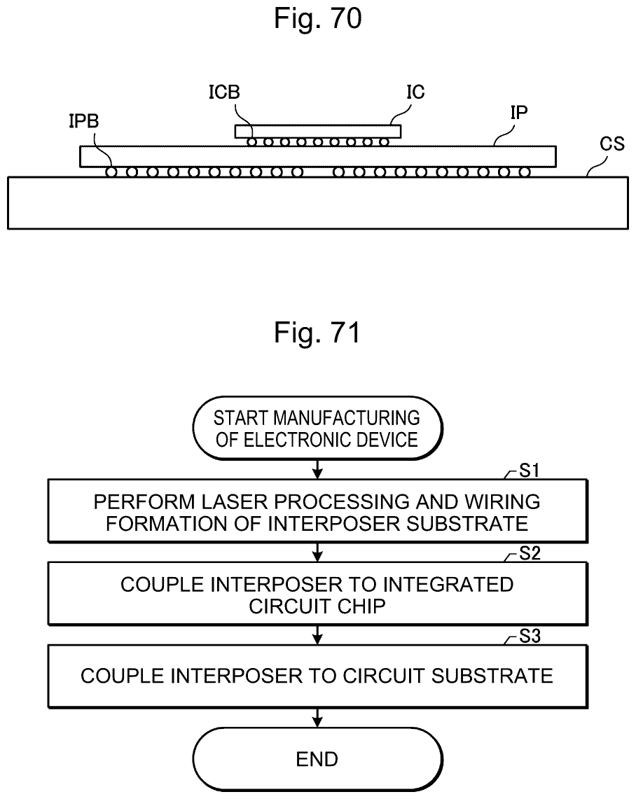

The laser irradiation apparatus 5 includes an irradiation optical system, which is not illustrated, for irradiating a workpiece, which is not illustrated, with the pulse laser beam Out and a laser irradiation processor 53 that controls the irradiation optical system. The workpiece is, for example, an interposer substrate for manufacturing an interposer IP that relays an integrated circuit chip IC and a circuit substrate CS, which will be described later with reference to FIG. 70. The laser irradiation processor 53 transmits and receives data and signals to and from the laser control processor 13.

### 1.2 Operation

In the laser apparatus 1, the laser control processor 13 receives data and a trigger signal of target pulse energy Et from the laser irradiation processor 53. The laser control processor 13 sets a voltage of the power supply device 12 on the basis of the target pulse energy Et and transmits a trigger signal to the power supply device 12.

Upon receiving the trigger signal from the laser control processor 13, the power supply device 12 generates a pulsed high voltage and applies it between the discharge electrodes 11a and 11b.

When the high voltage is applied between the discharge electrodes 11a and 11b, discharge occurs between the discharge electrodes 11a and 11b. Laser gas in the laser chamber 10 is excited by energy of the discharging and transitions to a higher energy level. Thereafter, when transitioning to a lower energy level, the excited laser gas emits light having a wavelength in accordance with the energy level difference.

The light generated in the laser chamber 10 outgoes to an outside of the laser chamber 10 through the windows 10a and 10b. The light outgoing from the window 10a of the laser chamber 10 is reflected by the rear mirror 14 at a high reflectance and is returned to the laser chamber 10. The light outgoing from the window 10b is reflected by the front mirror 15 at a high reflectance and is returned to the laser chamber 10.

In this manner, the light outgoing from the laser chamber 10 reciprocates between the rear mirror 14 and the front mirror 15 and is amplified every time the light passes through the discharge space between the discharge electrodes 11a and 11b. The optical path of the optical resonator is as described above with reference to FIG. 2. The pulse laser beam Out thus generated by laser oscillation is output from the optical resonator.

The pulse energy monitor 16 detects the pulse energy of the pulse laser beam Out output from the optical resonator. The pulse energy monitor 16 transmits data of the detected pulse energy to the laser control processor 13.

The laser control processor 13 feedback-controls a set voltage of the power supply device 12 on the basis of the data of the pulse energy received from the pulse energy monitor 16 and data of the target pulse energy Et received from the laser irradiation processor 53.

### 1.3 Reference Axis of Discharge Space

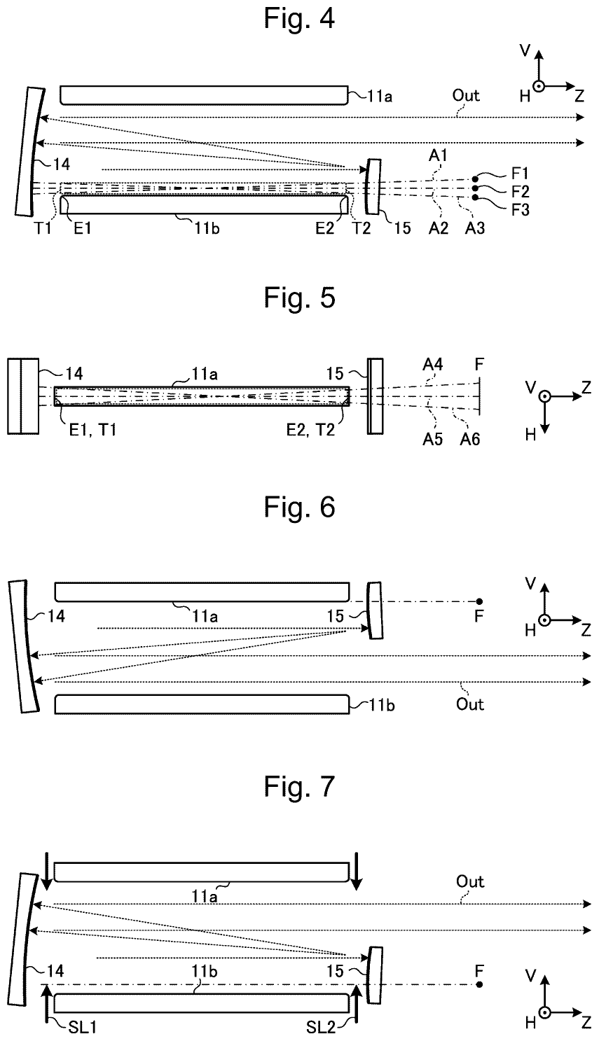

FIGS. 4 and 5 illustrate a positional relationship of the rear mirror 14, the front mirror 15, and the discharge electrodes 11a and 11b. FIG. 4 corresponds to the positional relationship as seen in the −H direction, and FIG. 5 corresponds to the positional relationship as seen in the −V direction. Here, a line parallel to the Z axis in a plane where the discharge electrode 11b is in contact with the discharge space is defined as a reference axis of the discharge space.

It is desirable that the optical axes Ar and Af (see FIG. 2) of the rear mirror 14 and the front mirror 15, that is, the optical axis of the optical resonator, be aligned to coincide with the reference axis of the discharge space. However, in a case where the radii of curvature R2 and R1 of the rear mirror 14 and the front mirror 15 are set to be considerably large as mentioned above, it may be difficult to determine the optical axis of the optical resonator with high precision. The optical axis of the optical resonator is allowed to deviate within the following range with respect to the reference axis of the discharge space.

Movement trajectories of a first ridge line E1 and a second ridge line E2 of the discharge electrode 11b when the discharge electrode 11b is moved by 3 mm towards the discharge electrode 11a and is then returned to its original position are denoted as T1 and T2, respectively. The first ridge line E1 is a ridge line of the discharge electrode 11b that is the closest to the discharge electrode 11a and is the closest to the rear mirror 14, while the second ridge line E2 is a ridge line of the discharge electrode 11b that is closest to the discharge electrode 11a and is the closest to the front mirror 15. A ridge line in a case where a part of an electrode surface is a curved surface is assumed to be located on a line along which a plane that is in contact with the electrode surface and is parallel to a ZH plane and a plane that is parallel to a VH plane intersect each other.

It is only necessary for the optical axis of the optical resonator to pass through the movement trajectory T1 and to pass through the movement trajectory T2. For example, the optical axis of the optical resonator may be any of A1 to A6 illustrated in FIGS. 4 and 5, and the focal axes F of the rear mirror 14 and the front mirror 15 may be any of F1 to F3 illustrated in FIG. 4.

It may be difficult to determine, with high precision, not only the optical axis of the optical resonator but also the focal axes F of the rear mirror 14 and the front mirror 15. The positions of the focal axes F of the rear mirror 14 and the front mirror 15 in the Z direction may be offset from each other within a range of equal to or less than 5% of the resonator length L.

FIG. 6 illustrates another example of the positional relationship of the rear mirror 14, the front mirror 15, and the discharge electrodes 11a and 11b. The optical axis of the optical resonator may be aligned with the discharge electrode 11a instead of the discharge electrode 11b. In other words, the reference axis of the discharge space may be a line parallel to the Z axis in a plane where the discharge electrode 11a is in contact with the discharge space.

FIG. 7 illustrates yet another example of the positional relationship of the rear mirror 14, the front mirror 15, and the discharge electrodes 11a and 11b. In a case where the optical path of the optical resonator is restricted by V-direction slits SL1 and SL2, the reference axis of the discharge space is defined by the positions of the V-direction slits SL1 and SL2 instead of the position of the discharge electrode 11b. The positions of the V-direction slits SL1 and SL2 serve as references in regard to the range of allowable deviation explained with reference to FIGS. 4 and 5 as well.

In a case where the optical path of the optical resonator is restricted by an H-direction slit, which is not illustrated, the range of allowable deviation is limited by the width of the H-direction slit instead of the widths of the discharge electrodes 11a and 11b in the H direction.

### 1.4 Problem in Comparative Example

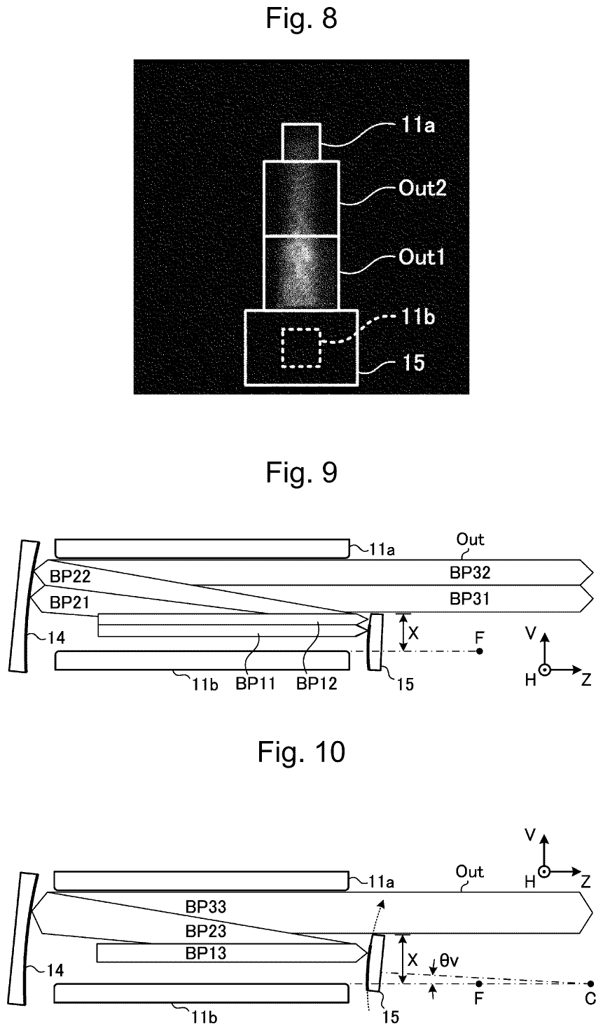

FIG. 8 is a grayscale photograph showing, by brightness/darkness, light intensity distribution of the pulse laser beam Out output from the optical resonator in a comparative example. The parts with higher light intensity are illustrated in lighter colors, that is, colors closer to white. In FIG. 8, the approximate positions of the discharge electrodes 11a and 11b and the front mirror 15 are indicated by the white outlines. The section of the pulse laser beam Out includes a region with a high light intensity in a first part Out1 close to the optical axis of the optical resonator and includes a region with a low light intensity in a second part Out2 far from the optical axis of the optical resonator. In such a region with a low light intensity, an M² value is large, and beam quality is low. Moreover, the pulse energy of the pulse laser beam Out may become insufficient due to the region with a low light intensity included.

FIG. 9 schematically illustrates a designed optical path of the optical resonator in the comparative example. It is assumed that a part of light reciprocating between the rear mirror 14 and the front mirror 15 passes through optical paths BP11 and BP12 that are parallel to the optical axis of the optical resonator and is then incident on the front mirror 15. At this time, light reflected by the front mirror 15 passes through optical paths BP21 and BP22, which diverge radially around the focal axis F, and is then incident on the rear mirror 14. Light reflected by the rear mirror 14 passes through optical paths BP31 and BP32 that are parallel to the optical axis of the optical resonator, and if there are no light-shielding components such as the front mirror 15 on that optical paths, then the light is output as the pulse laser beam Out.

Here, if the light intensity is low and the M² value is large in the second part Out2 far from the optical axis of the optical resonator as illustrated in FIG. 8, it is conceivable that some problem has occurred somewhere in the optical paths BP12, BP22, and BP32. As one possibility, it is conceivable that a problem has occurred at an end portion of the front mirror 15 in the V direction. For example, it may be difficult to perform accurate work to obtain the convex shape of the reflective surface of the front mirror 15 near the end portion of the front mirror 15. Alternatively, in a case where a reflective film of the front mirror 15 is a dielectric multilayer film with a thickness of several micrometers, the film thickness may be uneven near the end portion of the front mirror 15. If there is such a problem, a part of the reflective surface of the front mirror 15 where the light having passed through the optical path BP12 is incident may reflect the light in an unintended direction, or reflectance may be insufficient. As a result, the light having passed through the optical path BP12 may not propagate sufficiently to the optical paths BP22 and BP32, leading to low light intensity in the second part Out2. Also, since a large amount of unoscillated spontaneously released light generated in the optical paths BP22 and BP32 is contained in the second part Out2 instead of the light having reciprocated in the optical resonator and having subjected to laser oscillation, this may lead to the large M² value. In the following description, the region with a low light intensity may be referred to as an ASE region, and a region with a high light intensity may be referred to as an oscillation region.

An object of embodiments described below is to provide a laser apparatus or a method of controlling the laser apparatus that outputs a pulse laser beam Out with a small M² value, high beam quality, and a large pulse energy by reducing a region with a low light intensity included in the pulse laser beam Out.

### 2. Laser Apparatus 1a for Adjusting Position of Front Mirror 15

### 2.1 Basic Concept

FIG. 10 schematically illustrates arrangement of an optical resonator in a first embodiment. The amount by which a front mirror 15 protrudes in a discharge direction from a reference axis of a discharge space is defined as the amount X of protrusion, and the position of the front mirror 15 is adjusted to increase the amount X of protrusion. In this manner, light incident on a part slightly spaced apart from an end portion of the front mirror 15 through an optical path BP13 is output as a pulse laser beam Out through optical paths BP23 and BP33. On the other hand, light incident near the end portion of the front mirror 15 is not output as the pulse laser beam Out since the light is blocked by a discharge electrode 11a, for example, even if the light is reflected by the front mirror 15 as designed.

When the amount X of protrusion of the front mirror 15 is changed, it is only necessary to rotate the front mirror 15 by an angle θv using, as a rotation axis, a center axis C of a columnar surface configuring a reflective surface of the front mirror 15 in principle. This suppresses deviation of the reflective surface of the front mirror 15 from the columnar surface around the above rotation axis. However, since a rotation stage including the central axis C as a rotation axis increases in size, a first actuator 151 for adjusting the position of the front mirror 15 in the V direction and a second actuator 152 for performing adjustment about an axis parallel to the H axis are independently provided as will be described later.

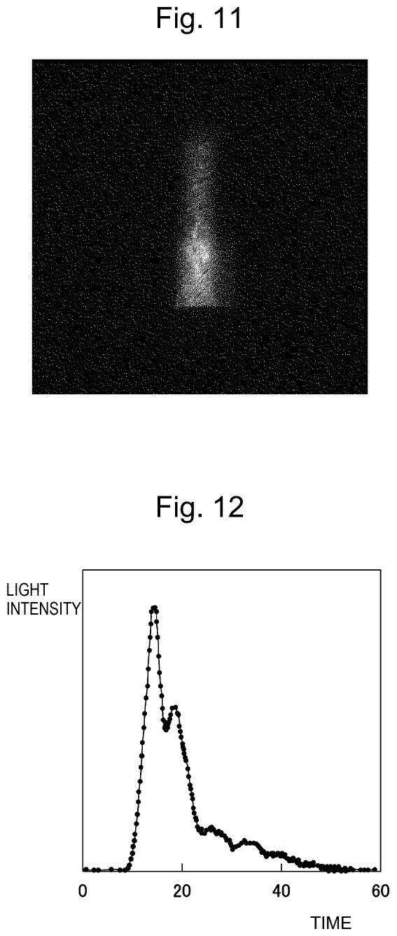

FIG. 11 is a grayscale photograph showing, by brightness/darkness, light intensity distribution of the pulse laser beam Out output from the optical resonator in the comparative example. In order to illustrate the light intensity distribution of the pulse laser beam Out more clearly, outlines indicating the positions of the discharge electrodes 11a and 11b and the front mirror 15 in FIG. 8 are omitted in FIG. 11. The amount X of protrusion of the front mirror 15 in the comparative example is 2.5 mm.

FIG. 12 is a graph illustrating a pulse time waveform of the pulse laser beam Out output from the optical resonator in the comparative example. A pulse time width ΔT of the pulse laser beam Out is 17.58 ns, and pulse energy is 20 mJ. The pulse time width ΔT is calculated by the following expression using a light intensity I(t).

ΔT=[∫I(t)dt]²/∫I(t)²dt

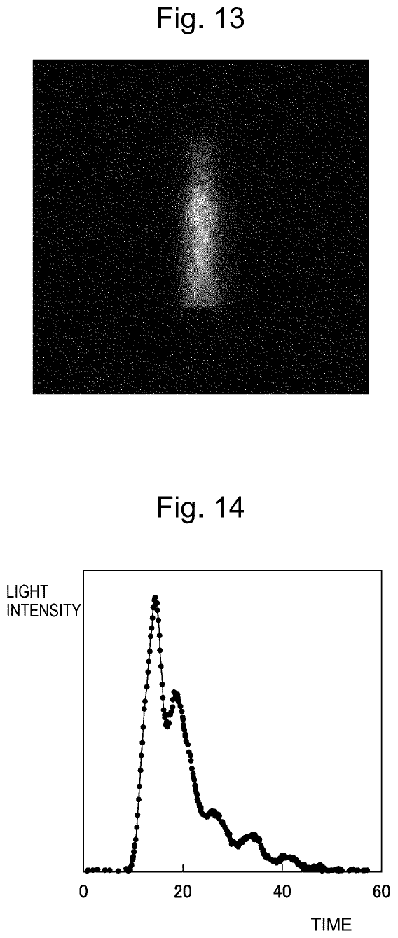

FIG. 13 is a grayscale photograph showing, by brightness/darkness, light intensity distribution of the pulse laser beam Out output from the optical resonator in a case where the amount X of protrusion is set to a first value in the first embodiment. The image angle and the imaging direction in FIG. 13 are the same as those in FIG. 11. Here, the first value is 3.0 mm, which is 0.5 mm longer than the amount X of protrusion in the comparative example. In this manner, light incident on the part of less than 0.5 mm from the end portion of the front mirror 15 is not output as the pulse laser beam Out, while light incident in the part spaced apart from the end portion of the front mirror 15 by equal to or greater than 0.5 mm is output as the pulse laser beam Out via the rear mirror 14.

FIG. 14 is a graph showing the pulse time waveform of the pulse laser beam Out output from the optical resonator in a case where the amount X of protrusion is set to the first value. The pulse time width ΔT of the pulse laser beam Out is 18.48 ns, and the pulse energy is 25 mJ. Although if the amount X of protrusion is set to be larger than that in the comparative example, the gap between the discharge electrode 11a and the front mirror 15 is narrowed, and the outgoing port of the pulse laser beam Out is narrowed, the pulse energy of the output light does not decrease and rather increases. This is considered to be because an ASE region decreases and an oscillation region increases.

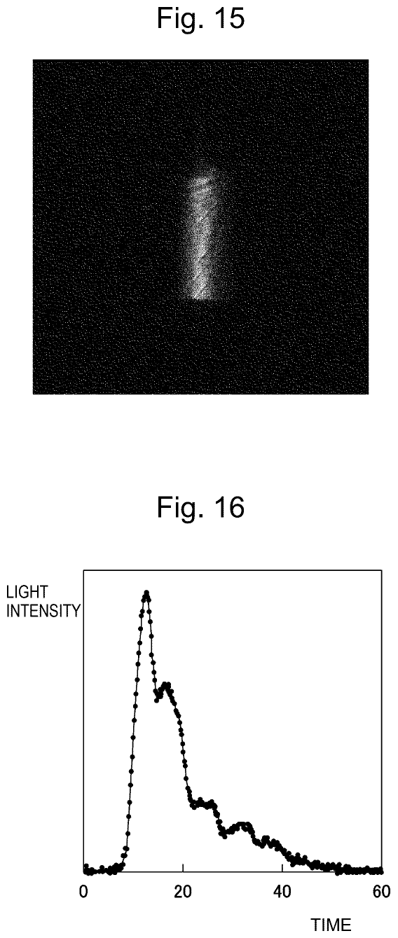

FIG. 15 is a grayscale photograph showing, by brightness/darkness, a light intensity distribution of the pulse laser beam Out output from the optical resonator in a case where the amount X of protrusion is set to a second value in the first embodiment. The image angle and the imaging direction in FIG. 15 are the same as those in FIG. 11 Here, the second value is 4.0 mm. The ASE region is hardly observed, and almost the entire beam section is the oscillation region by setting a yet larger amount X of protrusion than the first value. On the other hand, since the outgoing port of the pulse laser beam Out becomes narrower, the beam size in the V direction may become smaller.

FIG. 16 is a graph showing a pulse time waveform of the pulse laser beam Out output from the optical resonator in the case where the amount X of protrusion is set to the second value. The pulse time width ΔT of the pulse laser beam Out is 21.58 ns, and the pulse energy is 25 mJ.

The pulse time width ΔT increases, and in particular, the light intensity in the latter half of the pulse time waveform is high in the order of the comparative example (FIGS. 11 and 12), the case where the amount X of protrusion is set to the first value (FIGS. 13 and 14), and the case where the amount X of protrusion is set to the second value (FIGS. 15 and 16). This is considered to be because as the amount X of protrusion increases, the ratio of the ASE region decreases, and the ratio of the oscillation region increases, resulting in an increased proportion of light amplified while reciprocating in the optical resonator. On the other hand, there is not much change in pulse energy between the case where the amount X of protrusion is set to the first value and the case where the amount X of protrusion is set to the second value. This is considered to be because while the ratio of the oscillation region increases, the beam size in the V direction decreases. It is also considered that in a case where priority is placed only on an improvement in pulse energy, the first value may be sufficient. On the other hand, it is considered that in a case where priority is placed on reduction of the ASE region and an accompanying improvement in the Me value, the second value is more preferable than the first value.

In a pulse laser beam output from a stable resonator in which the rear mirror is a plane mirror and the front mirror is a partially reflective plane mirror, the M² value in the V direction may be, for example, 137.1, and the M² value in the H direction may be, for example, 7.1. In a case where the amount X of protrusion is set to the second value in the first embodiment, the Me value is significantly improved, is 10.0 in the V direction, and is 4.7 in the H direction.

### 2.2 Configuration

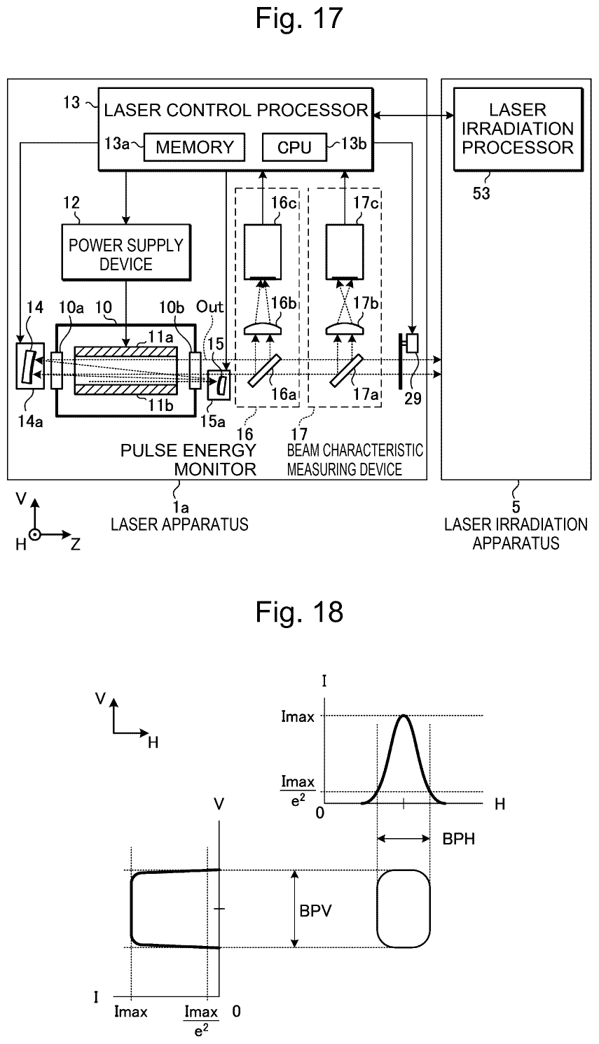

FIG. 17 schematically illustrates a configuration of a laser processing system in a first embodiment. In the first embodiment, a laser apparatus 1a includes a rear mirror stage 14a, a front mirror stage 15a, and a beam characteristic measuring device 17.

The beam characteristic measuring device 17 is a device that measures a beam characteristic to obtain an evaluation parameter value related to the oscillation region of the pulse laser beam Out.

In the first embodiment, the beam characteristic measuring device 17 is configured as a beam profiler that includes a beam splitter 17a, a transfer optical system 17b, and an image sensor 17c. The beam splitter 17a is located on the optical path of the pulse laser beam Out having been transmitted through the beam splitter 16a. The transfer optical system 17b is located on the optical path of the pulse laser beam Out having been reflected by the beam splitter 17a and forms an image of the beam section of the pulse laser beam Out on a light receiving surface of the image sensor 17c. The image sensor 17c acquires light intensity distribution of the beam section.

FIG. 18 illustrates an image of the beam section acquired by the beam characteristic measuring device 17, along with the light intensity distribution in the V direction and the H direction. The laser control processor 13 calculates a beam size BPV in the V direction as an evaluation parameter value from two-dimensional light intensity distribution acquired by the beam characteristic measuring device 17. The beam size BPV in the V direction is calculated, for example, as a full width of a part of the light intensity distribution in the V direction along the beam center in the H direction where the light intensity is equal to or greater than 1/e² a peak value Imax of a light intensity I. Alternatively, the beam size BPV in the V direction is calculated as a full width of a part of integrated light intensity distribution in the V direction obtained by integrating the two-dimensional light intensity distribution in the H direction for each position in the V direction where the integrated light intensity is equal to or greater than 1/e² the maximum integrated light intensity. Note that e is a Napier's constant.

The laser control processor 13 further calculates the area S of the oscillation region as an evaluation parameter value. The area S of the oscillation region is calculated, for example, as the area of the part of the two-dimensional light intensity distribution where the light intensity is equal to or greater than 1/e² the peak value Imax of the light intensity I. The area S of the oscillation region is an example of the alignment parameter value in the present disclosure.

As a beam size BPH in the H direction, the full width of the part of the light intensity distribution in the H direction along the beam center in the V direction where the light intensity is equal to or greater than 1/e² the peak value Imax of the light intensity I may be calculated. In the calculations of the beam sizes BPV and BPH and the area S, values such as 5% or 10% may be used instead of 1/e².

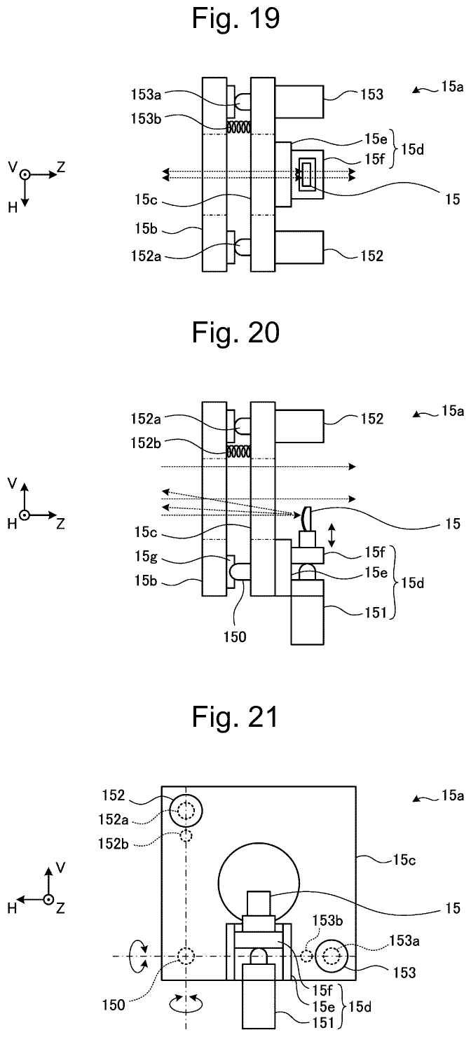

FIGS. 19 to 21 illustrate a configuration of the front mirror stage 15a. FIG. 19 corresponds to the front mirror stage 15a as seen in the −V direction, FIG. 20 corresponds to the front mirror stage 15a as seen in the −H direction, and FIG. 21 corresponds to the front mirror stage 15a as seen in the −Z direction. The front mirror stage 15a includes a fixed plate 15b and a movable plate 15c with the front mirror 15 supported by the movable plate 15c via a linear stage 15d. The fixed plate 15b and the movable plate 15c are provided with openings through which light passes. The front mirror stage 15a corresponds to the mirror stage in the present disclosure.

The linear stage 15d includes a rail 15e, a slider 15f, and a first actuator 151. The rail 15e is fixed to the movable plate 15c. The slider 15f supports the front mirror 15 and is movable in the direction of the V axis along the rail 15e. The first actuator 151 moves the slider 15f in the direction of the V axis, thereby moving the front mirror 15 in the direction of the V axis and adjusting the amount X of protrusion.

A fixed ball pin 150 is fixed to the movable plate 15c, with a second actuator 152 disposed at a position spaced apart from the fixed ball pin 150 in the V direction, and with a third actuator 153 disposed at a position spaced apart from the fixed ball pin 150 in the −H direction. The distal end of the fixed ball pin 150 is received in a recess provided in a mount 15g of the fixed plate 15b. A distal end 152a of the second actuator 152 is pressed against the fixed plate 15b by a tension spring 152b, and a distal end 153a of the third actuator 153 is pressed against the fixed plate 15b by a tension spring 153b.

Once the second actuator 152 is activated, the movable plate 15c rotates about an axis parallel to the H axis connecting the distal end of the fixed ball pin 150 to the distal end 153a of the third actuator 153, causing the front mirror 15 to rotate about an axis parallel to the H axis.

Once the third actuator 153 is activated, the movable plate 15c rotates about an axis parallel to the V axis connecting the distal end of the fixed ball pin 150 to the distal end 152a of the second actuator 152, causing the front mirror 15 to rotate about an axis parallel to the V axis.

It is desirable that the adjustment of the position of the front mirror 15 in the V direction and the adjustment of its posture be independent of each other, and for example, it is desirable that the change in position in the V direction when the front mirror 15 is adjusted around the axis parallel to the H axis be small.

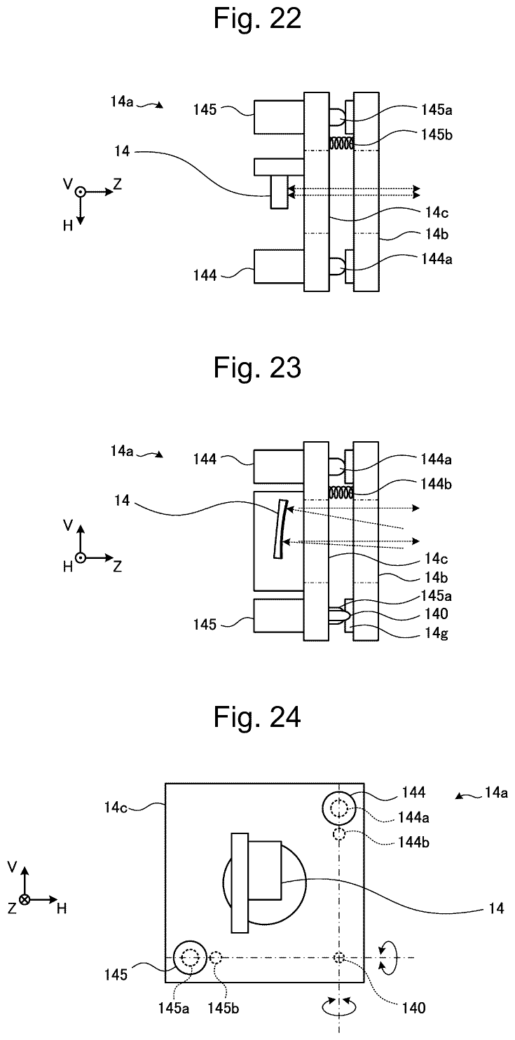

FIGS. 22 to 24 illustrate a configuration of the rear mirror stage 14a. FIG. 22 corresponds to the rear mirror stage 14a as seen in the −V direction, FIG. 23 corresponds to the rear mirror stage 14a as seen in the −H direction, and FIG. 24 corresponds to the rear mirror stage 14a as seen in the Z direction. The rear mirror stage 14a includes a fixed plate 14b and a movable plate 14c, with the rear mirror 14 supported by the movable plate 14c. The fixed plate 14b and the movable plate 14c are provided with openings through which light passes.

A fixed ball pin 140 is fixed to the movable plate 14c, with a fourth actuator 144 disposed at a position spaced apart from the fixed ball pin 140 in the V direction, and with a fifth actuator 145 disposed at a position spaced apart from the fixed ball pin 140 in the −H direction. The distal end of the fixed ball pin 140 is received in a recess provided in a mount 14g of the fixed plate 14b. A distal end 144a of the fourth actuator 144 is pressed against the fixed plate 14b by a tension spring 144b, and a distal end 145a of the fifth actuator 145 is pressed against the fixed plate 14b by a tension spring 145b.

Once the fourth actuator 144 is activated, the movable plate 14c rotates about an axis parallel to the H axis connecting the distal end of the fixed ball pin 140 to the distal end 145a of the fifth actuator 145, causing the rear mirror 14 to rotate about an axis parallel to the H axis.

Once the fifth actuator 145 is activated, the movable plate 14c rotates about an axis parallel to the V axis connecting the distal end of the fixed ball pin 140 to the distal end 144a of the fourth actuator 144, causing the rear mirror 14 to rotate about an axis parallel to the V axis.

### 2.3 Operation

### 2.3.1 Main Flow

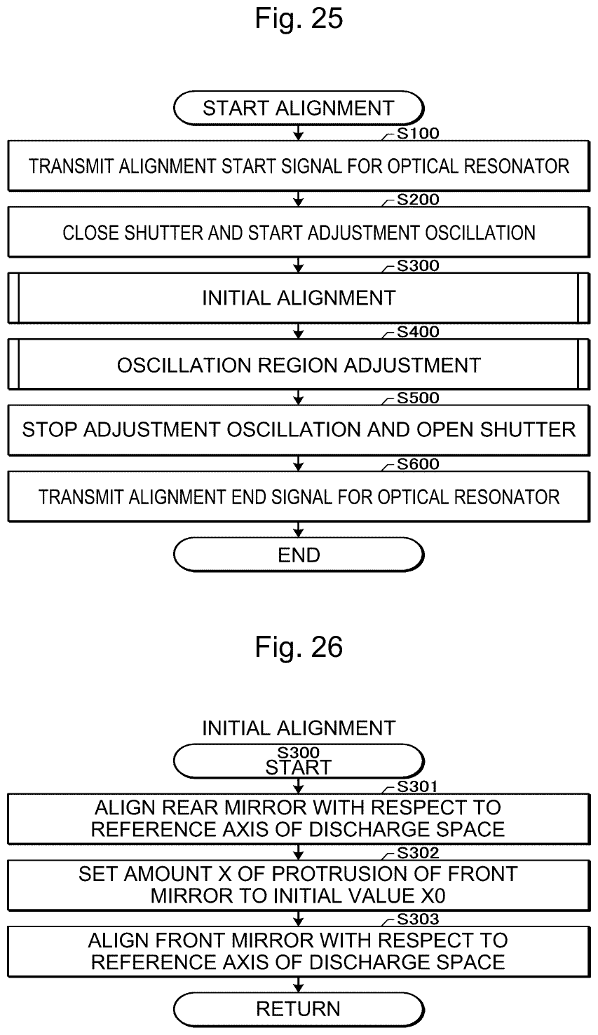

FIG. 25 is a flowchart illustrating an operation of alignment in the first embodiment. The alignment of the optical resonator is performed by the laser control processor 13 controlling the laser apparatus 1a as follows.

In S100, the laser control processor 13 transmits an alignment start signal for the optical resonator to the laser irradiation processor 53. After S100 and until the end of S600, the laser irradiation apparatus 5 does not irradiate a workpiece with the pulse laser beam Out.

In S200, the laser control processor 13 closes the shutter 29 to prevent the pulse laser beam Out from being incident on the laser irradiation apparatus 5, generates a trigger signal for the power supply device 12, and starts adjustment oscillation.

In S300, the laser control processor 13 performs initial alignment of the optical resonator. The initial alignment includes controlling each actuator of the rear mirror stage 14a and the front mirror stage 15a to align the rear mirror 14 and the front mirror 15 with respect to the reference axis of the discharge space. Details of the initial alignment will be described later with reference to FIG. 26.

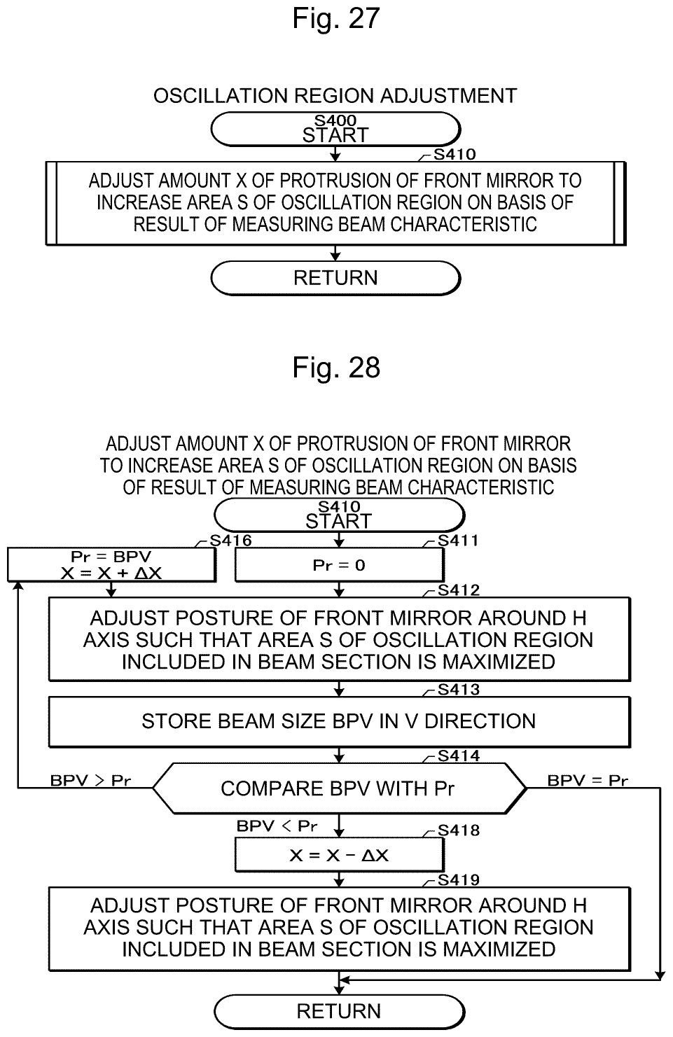

In S400, the laser control processor 13 performs oscillation region adjustment by controlling each actuator of the front mirror stage 15a to increase the oscillation region of the pulse laser beam Out on the basis of an evaluation parameter value related to the oscillation region. Details of the oscillation region adjustment will be described later with reference to FIGS. 27 to 31.

In S500, the laser control processor 13 stops the adjustment oscillation and opens the shutter 29. In S600, the laser control processor 13 transmits an alignment end signal for the optical resonator to the laser irradiation processor 53. After S600, the laser control processor 13 ends the processing of this flowchart.

### 2.3.2 Operation of Initial Alignment

FIG. 26 is a flowchart illustrating details of the processing of the initial alignment in the first embodiment. The processing illustrated in FIG. 26 corresponds to a subroutine of S300 illustrated in FIG. 25.

In S301, the laser control processor 13 controls each actuator of the rear mirror stage 14a to align the rear mirror 14 with respect to the reference axis of the discharge space.

In S302, the laser control processor 13 sets the amount X of protrusion of the front mirror 15 to an initial value X0 and controls the first actuator 151 of the front mirror stage 15a such that the amount X of protrusion becomes near the initial value X0. The initial value X0 may be the amount X of protrusion designed such that light of the optical path BP12 having been incident near the end portion of the front mirror 15 in the V direction is reflected and then passes through the optical paths BP22 and BP32, similarly to the amount X of protrusion in the comparative example described with reference to FIG. 9.

In S303, the laser control processor 13 controls the second and third actuators 152 and 153 of the front mirror stage 15a to align the front mirror 15 with respect to the reference axis of the discharge space.

After S303, the laser control processor 13 ends the processing of this flowchart and returns to the processing illustrated in FIG. 25. Although the case where the laser control processor 13 controls various actuators has been described here, the initial alignment may also be performed manually.

### 2.3.3 Operation of Oscillation Region Adjustment

FIG. 27 is a flowchart illustrating details of the processing of the oscillation region adjustment in the first embodiment. The processing illustrated in FIG. 27 corresponds to a subroutine of S400 illustrated in FIG. 25.

In S410, the laser control processor 13 adjusts the amount X of protrusion of the front mirror 15 to increase the area S of the oscillation region on the basis of a result of measuring a beam characteristic by the beam characteristic measuring device 17. Details of the processing in S410 will be described later with reference to FIGS. 28 to 31.

After S410, the laser control processor 13 ends the processing of this flowchart and returns to the processing illustrated in FIG. 25.

### 2.3.3.1 Oscillation Region Adjustment to Search for Maximum Value of Evaluation Parameter Value

FIG. 28 is a flowchart illustrating details of a first example of the oscillation region adjustment in the first embodiment. The processing illustrated in FIG. 28 corresponds to a subroutine of S410 illustrated in FIG. 27.

In S411, the laser control processor 13 sets a previous value Pr used in S414 to an initial value 0.

In S412, the laser control processor 13 controls the second actuator 152 to adjust the posture of the front mirror 15 around an axis parallel to the H axis such that the area S of the oscillation region included in the beam section of the pulse laser beam Out is maximized.

In S413, the laser control processor 13 stores the beam size BPV in the V direction when the posture of the front mirror 15 is adjusted in S412. The oscillation region when the posture of the front mirror 15 is adjusted in S412 corresponds to an improved oscillation region in the present disclosure, and the beam size BPV stored in S413 corresponds to an evaluation parameter value corresponding to the improved oscillation region. In this manner, the laser control processor 13 obtains the evaluation parameter value corresponding to the improved oscillation region, which is the oscillation region when the second actuator 152 is controlled such that the alignment parameter value of the optical resonator obtained from the beam characteristics is improved for each state where the front mirror 15 is moved to a plurality of positions by the first actuator 151.

In S414, the laser control processor 13 compares the beam size BPV in the V direction stored in S413 with the previous value Pr. In a case where the beam size BPV is larger than the previous value Pr (BPV>Pr), the laser control processor 13 moves on to the processing in S416. In a case where the beam size BPV is smaller than the previous value Pr (BPV<Pr), the laser control processor 13 moves on to the processing in S418. In a case where the beam size BPV is equal to the previous value Pr (BPV=Pr), the laser control processor 13 regards the beam size BPV as having reached its maximum value, ends the processing of this flowchart, and returns to the processing illustrated in FIG. 27.

In S416, the laser control processor 13 updates the previous value Pr by setting the previous value Pr to the same value as the beam size BPV in the V direction stored in S413. Furthermore, the laser control processor 13 updates the setting value of the amount X of protrusion by adding a positive number ΔX to the current amount X of protrusion of the front mirror 15, and controls the first actuator 151 in accordance with the new setting value of the amount X of protrusion. After S416, the laser control processor 13 determines the change in beam size BPV based on the new setting value of the amount X of protrusion by performing the processing in S412 to S414 again.

In S418, the laser control processor 13 regards the amount X of protrusion of the front mirror 15 as having become excessively large, updates the setting value of the amount X of protrusion by subtracting the positive number ΔX from the current amount X of protrusion, and controls the first actuator 151 in accordance with the new setting value of the amount X of protrusion.

After S418, the laser control processor 13 controls the second actuator 152 to adjust the posture of the front mirror 15 around an axis parallel to the H axis such that the area S of the oscillation region included in the beam section of the pulse laser beam Out is maximized in S419. This processing is similar to S412.

After S419, the laser control processor 13 ends the processing of this flowchart and returns to the processing illustrated in FIG. 27.

Through the processing illustrated in FIG. 28, the maximum value of the beam size BPV is searched for with the first actuator 151 changing the amount X of protrusion. In this manner the position where the size of the improved oscillation region is maximized is determined from among the positions of the front mirror 15 controlled by the first actuator 151. Subsequently, except for the case where the second actuator 152 has already been adjusted (BPV=Pr), the second actuator 152 adjusts the posture of the front mirror 15 around an axis parallel to the H axis on the basis of the area S of the oscillation region in a state where the front mirror 15 is disposed to have the determined amount X of protrusion. It is thus possible to increase the ratio of the oscillation region and to reduce the M² value.

### 2.3.3.2 Oscillation Region Adjustment to Acquire Relationship of Amount X of Protrusion and Evaluation Parameter Value

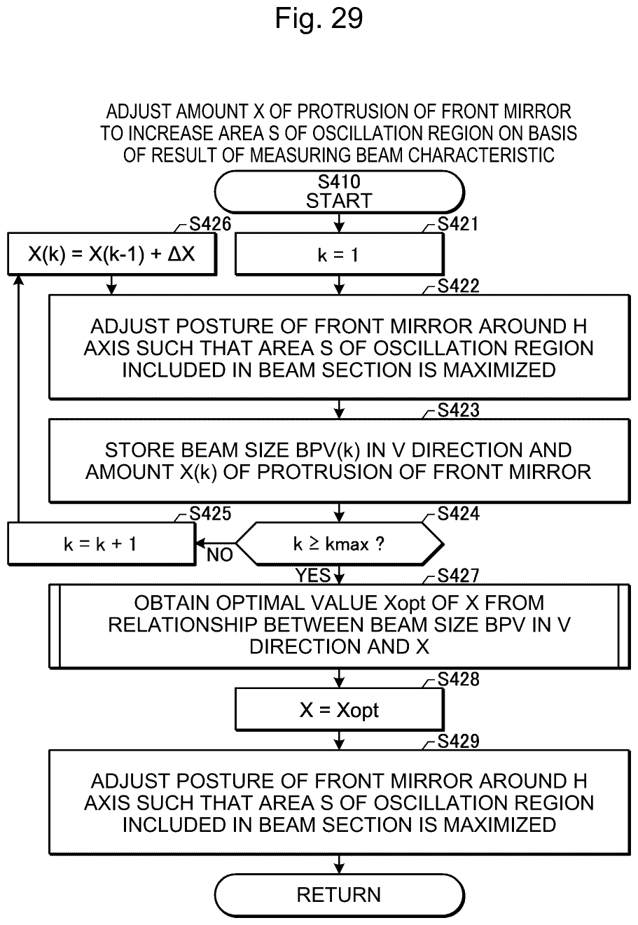

FIG. 29 is a flowchart illustrating details of a second example of the oscillation region adjustment in the first embodiment. The processing illustrated in FIG. 29 corresponds to a subroutine of S410 illustrated in FIG. 27.

In S421, the laser control processor 13 sets a counter k that counts the number kmax of plots of the amount X of protrusion to an initial value 1.

In S422, the laser control processor 13 controls the second actuator 152 to adjust the posture of the front mirror 15 around an axis parallel to the H axis such that the area S of the oscillation region included in the beam section of the pulse laser beam Out is maximized. This processing is similar to S412 (see FIG. 28).

In S423, the laser control processor 13 stores the beam size BPV (k) in the V direction and the amount X(k) of protrusion of the front mirror 15 when the posture of the front mirror 15 is adjusted in S422. In S423 and S426, which will be described later, the beam size BPV and amount X of protrusion corresponding to a specific value of the counter k are handled, and (k) is thus added to each of the reference signs. The oscillation region when the posture of the front mirror 15 is adjusted in S422 corresponds to the improved oscillation region in the present disclosure, and the beam size BPV (k) stored in S423 corresponds to the evaluation parameter value corresponding to the improved oscillation region. In this manner, the laser control processor 13 determines the position of the front mirror 15 controlled by the first actuator 151 on the basis of the relationship between the position of the front mirror 15 moved by the first actuator 151 and the evaluation parameter value corresponding to the improved oscillation region, which is the oscillation region when the second actuator 152 is controlled such that the alignment parameter value of the optical resonator obtained from the beam characteristic is improved in the state where the front mirror 15 is moved to the position.

In S424, the laser control processor 13 determines whether or not the value of the counter k has reached the number kmax of plots. In a case where the value of the counter k has not reached the number kmax of plots (S424: NO), the laser control processor 13 moves on to the processing in S425. In a case where the value of the counter k has reached the number kmax of plots (S424: YES), the laser control processor 13 moves on to the processing in S427.

In S425, the laser control processor 13 updates the value of k by adding 1 to the value of the counter k. After S425, the laser control processor 13 sets the amount X(k) of protrusion by adding the positive number ΔX to the amount X(k−1) of protrusion of the front mirror 15, and controls the first actuator 151 in accordance with the amount X(k) of protrusion in S426. After S426, the laser control processor 13 stores the setting value of the amount X(k) of protrusion and the corresponding beam size BPV (k) by performing the processing in S422 to S424 again. When the value of the counter k reaches the number kmax of plots, the setting values for the kmax amounts X(k) of protrusion and the beam size BPV (k) corresponding to each of them are stored as data indicating the relationship between the amount X of protrusion and the beam size BPV.

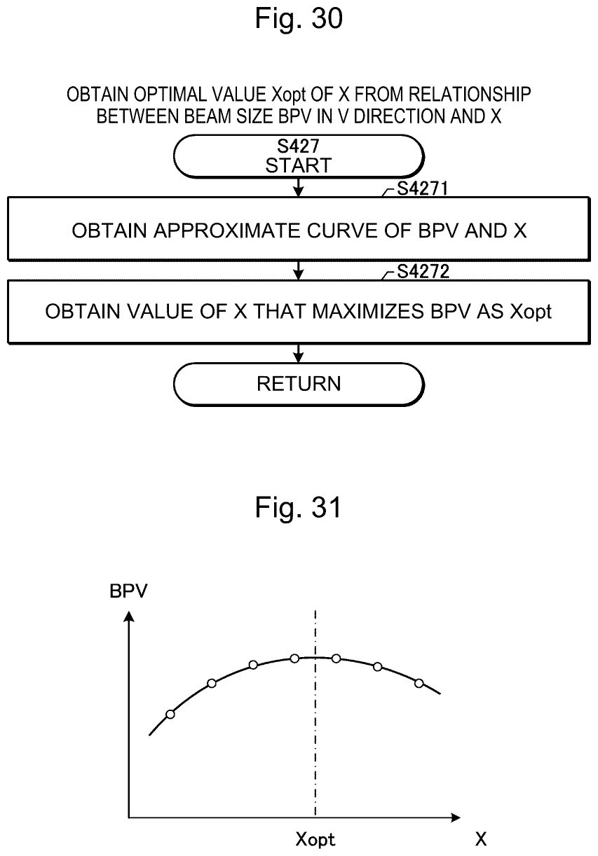

In S427, the laser control processor 13 obtains an optimal value Xopt of the amount X of protrusion from the relationship between the amount X of protrusion and the beam size BPV. Details of the processing in S427 will be described later with reference to FIGS. 30 and 31.

In S428, the laser control processor 13 sets the amount X of protrusion to the optimal value Xopt and controls the first actuator 151 in accordance with the optimal value Xopt.

After S428, the laser control processor 13 controls the second actuator 152 to adjust the posture of the front mirror 15 around an axis parallel to the H axis such that the area S of the oscillation region included in the beam section of the pulse laser beam Out is maximized in S429. This processing is similar to S422.

After S429, the laser control processor 13 ends the processing of this flowchart and returns to the processing illustrated in FIG. 27.

FIG. 30 is a flowchart illustrating details of the processing of obtaining the optimal value Xopt of the amount X of protrusion in the first embodiment. The processing illustrated in FIG. 30 corresponds to a subroutine of S427 illustrated in FIG. 29.

In S4271, the laser control processor 13 obtains an approximate curve showing the relationship between the amount X of protrusion and the beam size BPV.

In S4272, the laser control processor 13 obtains, as the optimal value Xopt, the value of the amount X of protrusion that maximizes the beam size BPV from the approximate curve. The optimal value Xopt does not have to be one of the kmax amounts X(k) of protrusion stored in S423 and may be a value between one of the amounts X(k) of protrusion and its subsequent X(k+1).

After S4272, the laser control processor 13 ends the processing of this flowchart and returns to the processing illustrated in FIG. 29.

FIG. 31 illustrates an example of the approximate curve obtained in FIG. 30. As the amount X of protrusion is increased from the initial value X0, the oscillation region increases and the ASE region decreases, causing the beam size BPV in the V direction to gradually increase. However, after there becomes substantially no ASE region, the ASE region does not further decrease even if the amount X of protrusion is increased, a part of the outgoing port of the pulse laser beam Out is rather blocked by the front mirror 15, and the beam size BPV in the V direction gradually decreases. It is possible to obtain a large oscillation region by obtaining the amount X of protrusion that maximizes the beam size BPV in the V direction.

Through the processing illustrated in FIGS. 29 to 31, the amount X of protrusion that maximizes the beam size BPV is determined, and the posture of the front mirror 15 is further adjusted around the axis parallel to the H axis, on the basis of the relationship between the amount X of protrusion and the beam size BPV in the V direction. It is thus possible to increase the ratio of the oscillation region and to reduce the M² value.

### 2.4 Effect

(1) According to the first embodiment, the discharge excitation laser apparatus 1a includes the laser chamber 10, the optical resonator including the front mirror 15 and the rear mirror 14, the front mirror stage 15a, the beam characteristic measuring device 17, and the laser control processor 13. The pair of discharge electrodes 11a and 11b are disposed in the laser chamber 10. The optical resonator forms an off-axis optical path along the first surface P1 parallel to the direction of the V axis, which is the discharge direction of discharge between the discharge electrodes 11a and 11b, and the direction of the Z axis, which is the longitudinal direction of the discharge electrodes 11a and 11b. The front mirror stage 15a includes the first actuator 151 that moves the front mirror 15 in the direction of the V axis and the second actuator 152 that rotates the front mirror 15 about the H axis perpendicularly intersecting the first plane P1. The beam characteristic measuring device 17 measures the beam characteristic of the pulse laser beam Out output from the optical resonator. The laser control processor 13 controls the first and second actuators 151 and 152 to increase the oscillation region on the basis of the evaluation parameter value related to the oscillation region of the pulse laser beam Out obtained from the beam characteristic.

According to this, it is possible to obtain a laser beam with a small Me value and high quality by controlling the position and the posture of the front mirror 15 to increase the oscillation region. Additionally, the pulse energy can be improved, and the pulse time width can also be extended.

(2) According to the first embodiment, the laser control processor 13 controls the first and second actuators 151 and 152 to align the front mirror 15 with respect to the reference axis of the discharge space between the discharge electrodes 11a and 11b. Thereafter, the laser control processor 13 controls the first and second actuators 151 and 152 on the basis of the evaluation parameter value.

According to this, control based on the evaluation parameter value is performed after the alignment with the reference axis of the discharge space, and it is thus possible to clarify the purpose of controlling the first and second actuators 151 and 152 in each control stage and to improve alignment precision.

(3) According to the first embodiment, the laser control processor 13 acquires the evaluation parameter value corresponding to the improved oscillation region, which is the oscillation region when the second actuator 152 is controlled to improve the alignment parameter value of the optical resonator obtained from the beam characteristic in each of states where the first actuator 151 moves the front mirror 15 to a plurality of positions. Furthermore, the laser control processor 13 determines the position at which the size of the improved oscillation region is maximized, from among the positions of the front mirror 15.

According to this, it is possible to obtain the optimal position of the front mirror 15 by specifying the position of the front mirror 15 at which the improved oscillation region is maximized.

(4) According to the first embodiment, the laser control processor 13 determines the position of the front mirror 15 controlled by the first actuator 151 on the basis of the relationship between the position of the front mirror 15 moved by the first actuator 151 and the evaluation parameter value corresponding to the improved oscillation region, which is the oscillation region when the second actuator 152 is controlled to improve the alignment parameter value of the optical resonator obtained from the beam characteristic in the state where the front mirror 15 is moved to the position.

According to this, it is possible to obtain the optimal position of the front mirror 15 with high precision.

(5) According to the first embodiment, the laser control processor 13 determines the position of the front mirror 15 controlled by the first actuator 151 on the basis of the evaluation parameter value. Subsequently, the laser control processor 13 controls the second actuator 152 on the basis of the alignment parameter value of the optical resonator obtained from the beam characteristic when the front mirror 15 is disposed at the determined position.

The laser may not oscillate with the posture of the front mirror 15 even if it is attempted to search for the optimal position after the posture of the front mirror 15 is determined. Since the laser is more likely to oscillate in a case where the posture is searched for after the optimal position of the front mirror 15 is determined, it is possible to more reliably determine the position and the posture of the front mirror 15.

(6) The beam characteristic measuring device 17 measures any of the following.
(a1) Light intensity distribution along the beam section of the pulse laser beam Out (first embodiment)
(a2) A pulse time waveform of the pulse laser beam Out (second embodiment)
(a3) A polarization component in the direction of the H axis perpendicular to the direction of the V axis in the pulse laser beam Out (third embodiment)
(a4) Light intensity distribution at a light condensing point of the pulse laser beam Out (fourth embodiment)
(a5) A partial beam characteristic in the second part Out2, which is far from the optical axis of the optical resonator in the beam section of the pulse laser beam Out

### Fifth Embodiment

It is possible to obtain the evaluation parameter value to determine the position of the front mirror 15 that increases the oscillation region with high precision by measuring any of the above.

(7) According to the first embodiment, the beam characteristic measuring device 17 is a beam profiler that measures the light intensity distribution along the beam section of the pulse laser beam Out. The laser control processor 13 controls the first actuator 151 using the width of the integrated light intensity distribution, which is obtained by integrating the light intensity distribution in the direction of the H axis intersecting the direction of the V axis, in the direction of the V axis as the evaluation parameter value.

According to this, it is possible to obtain an appropriate evaluation parameter value even in a case where the width of the oscillation region in the direction of the H axis is narrow, by using the integrated light intensity distribution obtained through the integral in the direction of the H axis.

(8) According to the first embodiment, the beam characteristic measuring device 17 is a beam profiler that measures the light intensity distribution along the beam section of the pulse laser beam Out. The laser control processor 13 controls the second actuator 152 on the basis of the area of the region where the light intensity is equal to or greater than a predetermined proportion with respect to the peak value Imax of the light intensity distribution.

According to this, it is possible to appropriately control the posture of the front mirror 15 by controlling the second actuator 152 to increase the area of the region where the light intensity is equal to or greater than the predetermined proportion.

In other respects, the first embodiment is similar to the comparative example.

### 3. Laser Apparatus 1b Using Pulse Time Width ΔT as Evaluation Parameter Value

### 3.1 Configuration

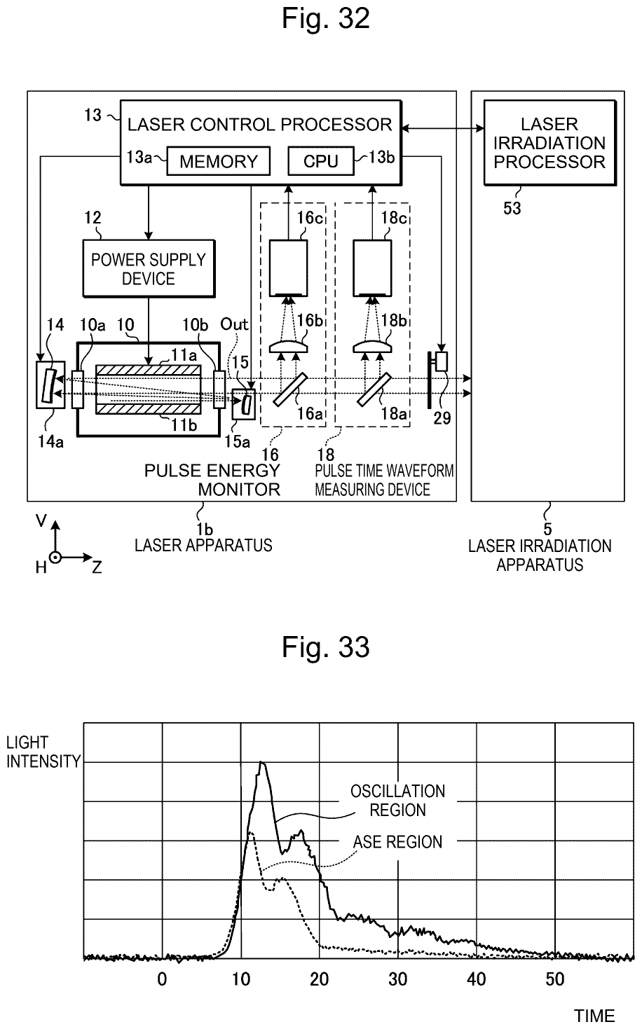

FIG. 32 schematically illustrates a configuration of a laser processing system in a second embodiment. In the second embodiment, a laser apparatus 1b includes a pulse time waveform measuring device 18 as a beam characteristic measuring device.

The pulse time waveform measuring device 18 includes a beam splitter 18a, a light condensing optical system 18b, and a high-speed photosensor 18c. The beam splitter 18a is located on an optical path of a pulse laser beam Out having been transmitted through the beam splitter 16a. The light condensing optical system 18b condenses the pulse laser beam Out reflected by the beam splitter 18a. The high-speed photosensor 18c is located on an optical path of the pulse laser beam Out having passed through the light condensing optical system 18b. The high-speed photosensor 18c may be, for example, a photoelectric tube such as a bi-planar tube or a high-speed photodiode.

A laser control processor 13 calculates a pulse time width ΔT on the basis of the pulse time waveform measured by the pulse time waveform measuring device 18.

FIG. 33 is a graph showing the pulse time waveform in each of an oscillation region and an ASE region of the pulse laser beam Out. The pulse time waveform in the oscillation region is the pulse time waveform obtained by shielding the second part Out2 of the pulse laser beam Out (see FIG. 8) and allowing the first part Out1 to be incident on the pulse time waveform measuring device 18 in the comparative example, for example. The pulse time waveform in the ASE region is the pulse time waveform obtained by shielding the first part Out1 and allowing the second part Out2 to be incident on the pulse time waveform measuring device 18, for example. It is possible to ascertain from FIG. 33 that the pulse time width in the ASE region is shorter than the pulse time width in the oscillation region. Therefore, it is considered that when the ratio of the oscillation region included in the pulse laser beam Out is small and the ratio of the ASE region is large, the pulse time width ΔT of the entire beam section of the pulse laser beam Out becomes short. On the contrary, when the ratio of the oscillation region is large and the ratio of the ASE region is small, the pulse time width ΔT of the entire beam section of the pulse laser beam Out becomes long. Therefore, the pulse time width ΔT is calculated as the evaluation parameter value, and the position and the posture of the front mirror 15 are controlled to increase the oscillation region in the second embodiment.

### 3.2 Operation of Oscillation Region Adjustment

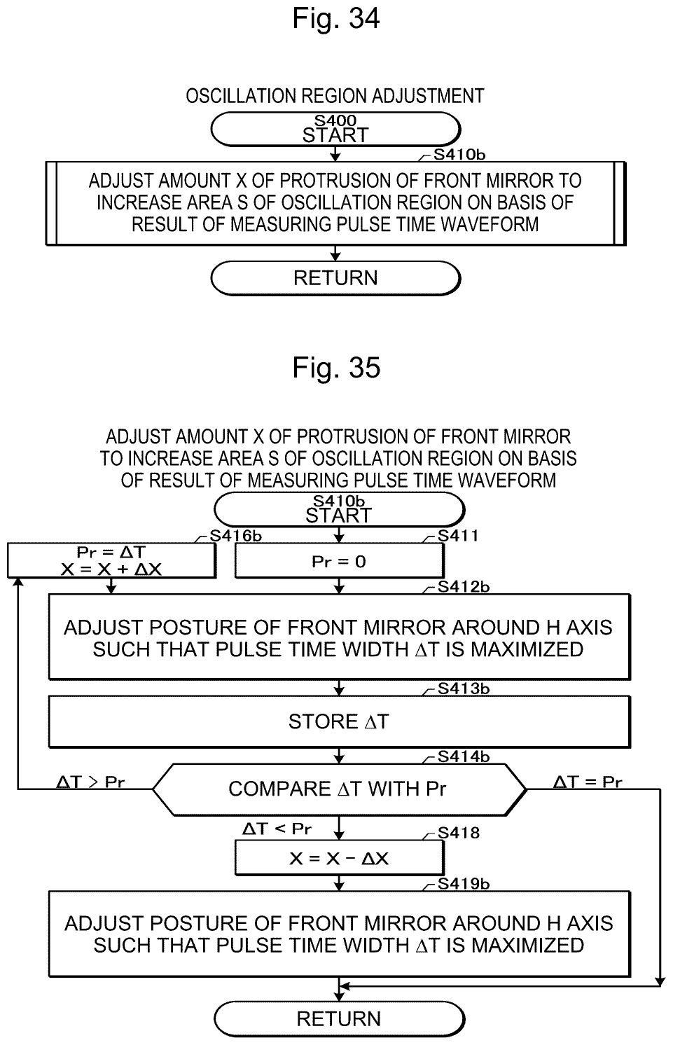

FIG. 34 is a flowchart illustrating details of processing of oscillation region adjustment in the second embodiment. The processing illustrated in FIG. 34 corresponds to a subroutine of S400 illustrated in FIG. 25.

In S410b, the laser control processor 13 adjusts the amount X of protrusion of the front mirror 15 to increase the area S of the oscillation region on the basis of the result of measuring the pulse time waveform by the pulse time waveform measuring device 18. Details of the processing in S410b will be described later with reference to FIGS. 35 to 41.

After S410b, the laser control processor 13 ends the processing of this flowchart and returns to the processing illustrated in FIG. 25.

### 3.2.1 Oscillation Region Adjustment to Search for Maximum Value of Evaluation Parameter Value

FIG. 35 is a flowchart illustrating details of a first example of the oscillation region adjustment in the second embodiment. The processing illustrated in FIG. 35 corresponds to a subroutine of S410b illustrated in FIG. 34.

The processing illustrated in FIG. 35 is similar to the processing illustrated in FIG. 28 other than that the area S of the oscillation region in FIG. 28 is replaced with the pulse time width ΔT and the beam size BPV in the V direction in FIG. 28 is replaced with the pulse time width ΔT. Note that “b” is added to ends of step numbers where the above replacement is made.

The amount X of protrusion is determined, and the posture of the front mirror 15 is further adjusted around an axis parallel to the H axis by searching for the maximum value of the pulse time width ΔT while changing the amount X of protrusion through the processing illustrated in FIG. 35. It is thus possible to increase the ratio of the oscillation region and to reduce the M² value.

### 3.2.2 Oscillation Region Adjustment to Acquire Relationship of Amount X of Protrusion and Evaluation Parameter Value

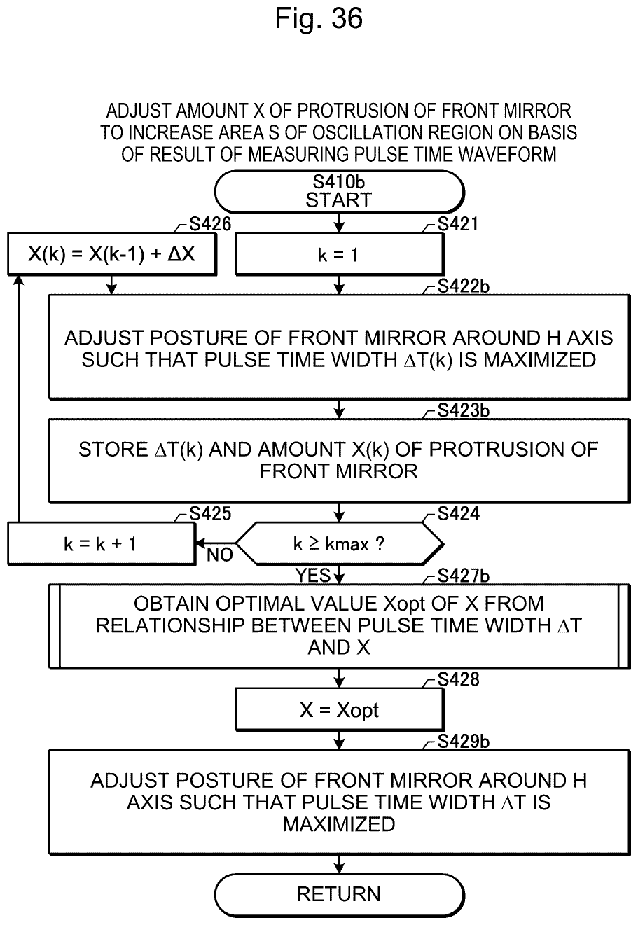

FIG. 36 is a flowchart illustrating details of a second example of the oscillation region adjustment in the second embodiment. The processing illustrated in FIG. 36 corresponds to a subroutine of S410b illustrated in FIG. 34.

The processing illustrated in FIG. 36 is similar to the processing illustrated in FIG. 29 other than that the area S of the oscillation region in FIG. 29 is replaced with the pulse time width ΔT (k) or ΔT and the beam size BPV (k) and BPV in the V direction in FIG. 29 are replaced with the pulse time width ΔT (k) and ΔT. Note that “b” is added to ends of step numbers where the above replacement is made.

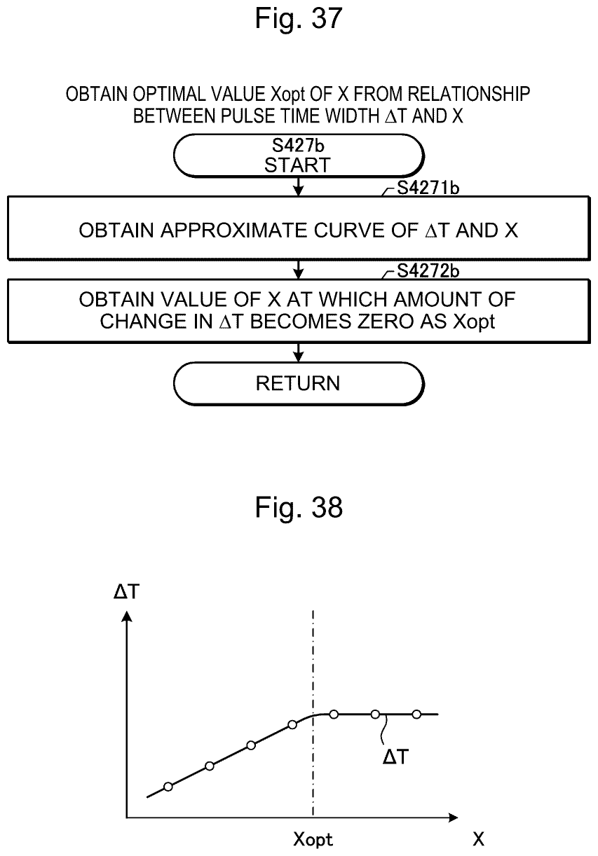

FIG. 37 is a flowchart illustrating details of processing to obtain the optimal value Xopt of the amount X of protrusion in the second embodiment. The processing illustrated in FIG. 37 corresponds to a subroutine of S427b illustrated in FIG. 36.

In S4271b, the laser control processor 13 obtains an approximate curve showing a relationship between the amount X of protrusion and the pulse time width ΔT.

In S4272b, the laser control processor 13 obtains, as the optimal value Xopt, the value of the amount X of protrusion at which amount of change in pulse time width ΔT becomes zero from the approximate curve. The amount of change becoming zero means that the amount of change becomes a value that is substantially zero and does not mean that no change occurs at all.

After S4272b, the laser control processor 13 ends the processing of this flowchart and returns to the processing illustrated in FIG. 36.

FIG. 38 illustrates an example of the approximate curve obtained in FIG. 37. As the amount X of protrusion is increased from the initial value X0, the oscillation region increases and the ASE region decreases, causing the pulse time width ΔT to gradually increase. However, after there becomes substantially no ASE region, the ASE region does not further decrease even if the amount X of protrusion is increased, substantially the entire beam section of the pulse laser beam Out becomes the oscillation region, and the amount of change in pulse time width ΔT becomes zero. It is possible to obtain a large oscillation region by obtaining the amount X of protrusion at which the amount of change in pulse time width ΔT becomes zero.

Through the processing illustrated in FIGS. 36 to 38, the amount X of protrusion at which the amount of change in pulse time width Δt becomes zero is determined, and the posture of the front mirror 15 is further adjusted around the axis parallel to the H axis, on the basis of the relationship between the amount X of protrusion and the pulse time width ΔT. It is thus possible to increase the ratio of the oscillation region and to reduce the M² value.

### 3.2.3 Oscillation Region Adjustment to Acquire Relationship of Amount X of Protrusion and Plurality of Evaluation Parameter Values

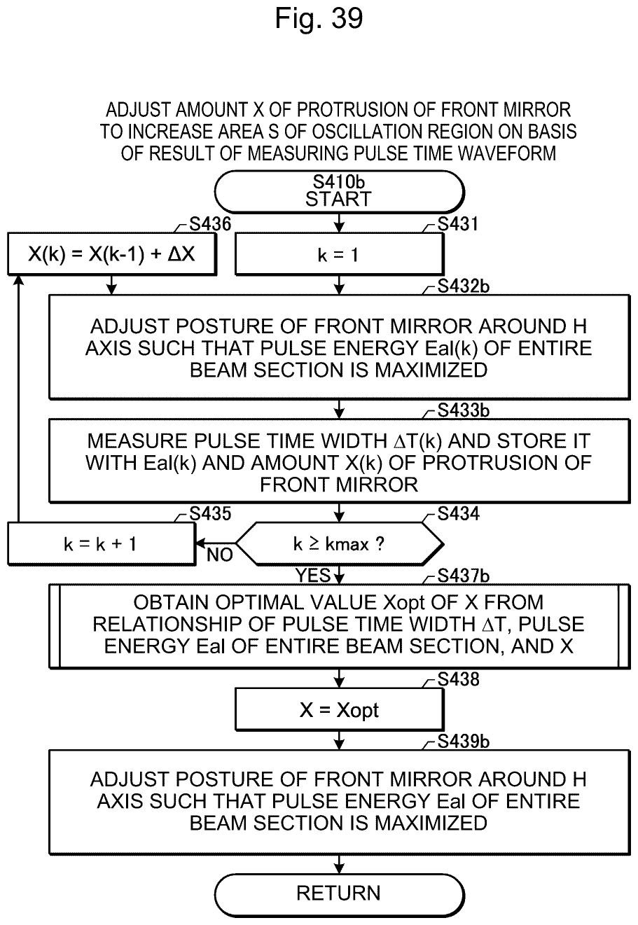

FIG. 39 is a flowchart illustrating details of a third example of the oscillation region adjustment in the second embodiment. The processing illustrated in FIG. 39 corresponds to a subroutine of S410b illustrated in FIG. 34.

In FIG. 39, processing (S432b and S439b) of adjusting the posture of the front mirror 15 to maximize the pulse energy Eal(k) or Eal of the entire beam section measured by the pulse energy monitor 16 is performed instead of the processing (S422b and S429b) of adjusting the posture of the front mirror 15 to maximize the pulse time width ΔT (k) or ΔT in FIG. 36. In FIG. 39, the pulse energy Eal(k) is also stored (S433b) in addition to the storing of the pulse time width ΔT (k) and the amount X(k) of protrusion (S423b). In FIG. 39, the optimal value Xopt is obtained using not only the relationship between the pulse time width ΔT and the amount X of protrusion (S427b) but also the relationship between the pulse energy Eal and the amount X of protrusion (S437b). Note that the step numbers in FIG. 39 have been rewritten by the numbers starting with S43. In other respects, the processing illustrated in FIG. 39 is similar to that in FIG. 36.

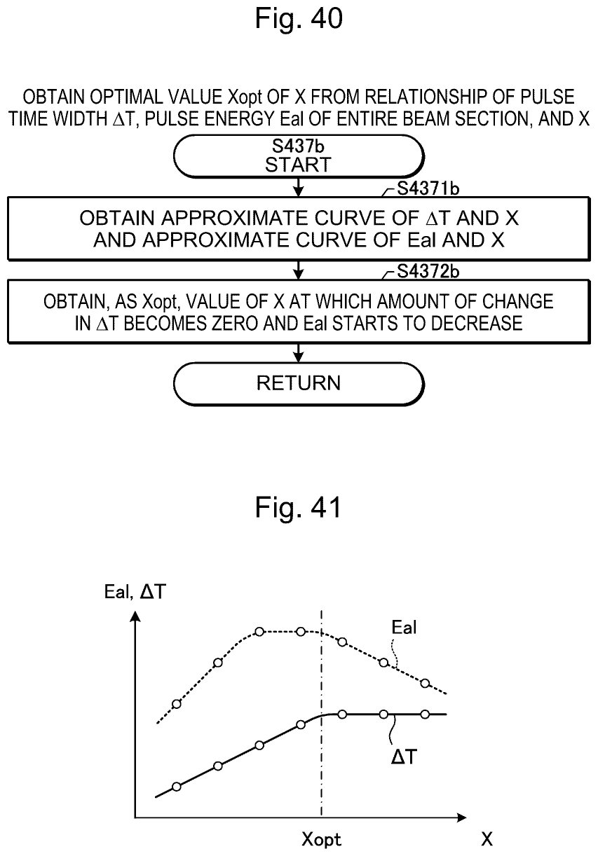

FIG. 40 is a flowchart illustrating details of the processing to obtain the optimal value Xopt of the amount X of protrusion from a plurality of evaluation parameter values in the second embodiment. The processing illustrated in FIG. 40 corresponds to a subroutine of S437b illustrated in FIG. 39.

In S4371b, the laser control processor 13 obtains not only the approximate curve indicating the relationship between the amount X of protrusion and the pulse time width ΔT but also the approximate curve indicating the relationship between the amount X of protrusion and the pulse energy Eal.

In S4372b, the laser control processor 13 obtains, as the optimal value Xopt, the value of the amount X of protrusion at which the amount of change in pulse time width ΔT becomes zero and the pulse energy Eal starts to decrease from the two approximate curves.

After S4372b, the laser control processor 13 ends the processing of this flowchart and returns to the processing illustrated in FIG. 39.

FIG. 41 illustrates examples of the two approximate curves obtained in FIG. 40. As the amount X of protrusion is increased from the initial value X0, the oscillation region increases and the ASE region decreases, causing the pulse energy Eal to gradually increase. However, although the ratio of the oscillation region increases due to a further decrease in ASE region with the increase in the amount X of protrusion, the size of the oscillation region hits its peak, and the change in pulse energy Eal becomes slow. After there becomes substantially no ASE region, the ASE region does not further decrease even if the amount X of protrusion is increased, a part of the outgoing port of the pulse laser beam Out is rather blocked by the front mirror 15, and the pulse energy Eal decreases. Therefore, the amount X of protrusion at which the amount of change in pulse time width ΔT becomes zero and the pulse energy Eal starts to decrease is obtained. For example, the amount X of protrusion at which a value obtained by adding products of the pulse time width ΔT and the pulse energy Eal multiplied by their weighting coefficients becomes a peak may be defined as the optimal value Xopt.

Through the processing illustrated in FIGS. 39 to 41, the amount X of protrusion is determined, and the posture of the front mirror 15 is further adjusted around the axis parallel to the H axis, on the basis of the relationships between the amount X of protrusion and the pulse time width ΔT and between the amount X of protrusion and the pulse energy Eal. It is thus possible to increase the ratio of the oscillation region and to reduce the M² value.

### 3.3 Effect

(9) According to the second embodiment, the beam characteristic measuring device includes the pulse time waveform measuring device 18 configured to measure the pulse time waveform of the pulse laser beam Out. The laser control processor 13 controls the first and second actuators 151 and 152 using the pulse time width ΔT obtained from the pulse time waveform as the evaluation parameter value.

Since the oscillation region is the part where light is amplified while reciprocating in the optical resonator, the pulse time width thereof is longer than that of the ASE region. It is possible to estimate the size of the oscillation region by using the pulse time width ΔT as the evaluation parameter value.

(10) According to the second embodiment, the pulse energy monitor 16 configured to measure the pulse energy Eal of the pulse laser beam Out is included. In addition, the beam characteristic measuring device includes the pulse time waveform measuring device 18 configured to measure the pulse time waveform of the pulse laser beam Out. The laser control processor 13 controls the first actuator 151 using the pulse time width ΔT obtained from the pulse time waveform as the evaluation parameter value. The laser control processor 13 controls the second actuator 152 on the basis of the pulse energy Eal.

According to this, it is possible to appropriately control the posture of the front mirror 15 by using the pulse energy Eal of the entire beam section.

(11) According to the second embodiment, the laser control processor 13 controls the first actuator 151 on the basis of both the pulse time width ΔT and the pulse energy Eal.

The pulse energy Eal may be large even when the amount X of protrusion of the front mirror 15 is smaller than the optimal value Xopt, and the pulse time width ΔT may be large even when the amount X of protrusion is larger than the optimal value Xopt. It is possible to improve precision by taking both the pulse energy Eal and the pulse time width ΔT into consideration.

In other respects, the second embodiment is similar to the first embodiment. Although the case where the pulse time width ΔT obtained from the pulse time waveform is used as the evaluation parameter value has been described in the second embodiment, the present disclosure is not limited thereto. The area of the latter half part of the pulse time waveform, for example, the area of the part after elapse of 20 ns from the rise of the pulse may be used as the evaluation parameter value.

### 4. Laser Apparatus 1c Using Result of Measuring Polarization as Evaluation Parameter Value

### 4.1 Configuration

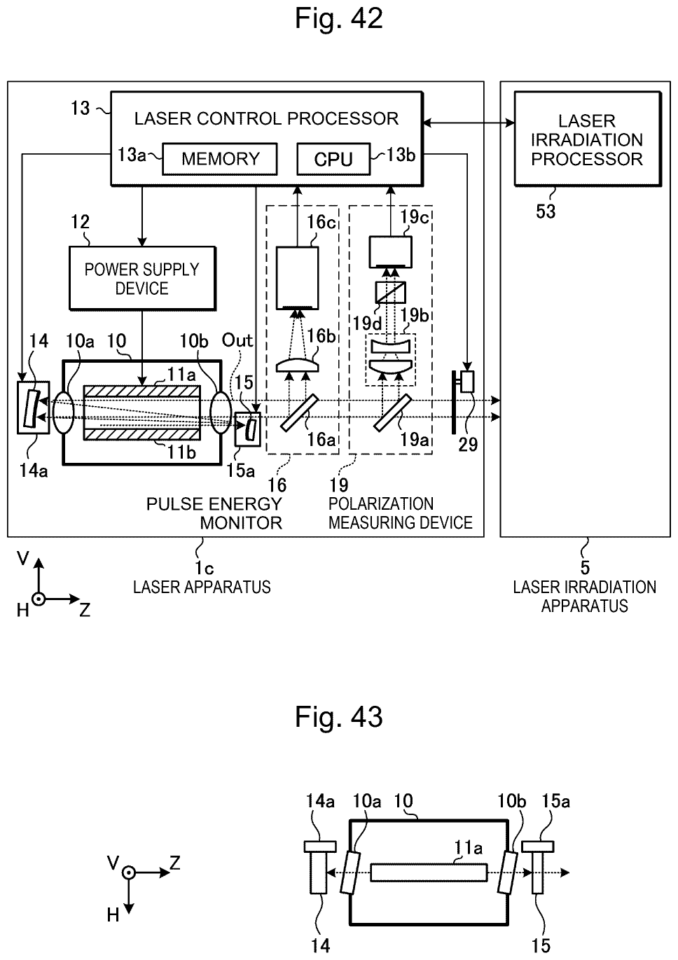

FIG. 42 schematically illustrates a configuration of a laser processing system in a third embodiment. In the third embodiment, a laser apparatus 1c includes a polarization measuring device 19 as a beam characteristic measuring device.

FIG. 43 is an optical resonator and a laser chamber 10 in the third embodiment as seen in the −V direction. Windows 10a and 10b disposed on an optical path of the optical resonator are disposed with an inclination such that light incident surfaces are parallel to an HZ plane and the incident angles are substantially a Brewster's angle. In this manner, a polarization component having P polarization with respect to the windows 10a and 10b when light reciprocating in the optical resonator is transmitted through the windows 10a and 10b is selected. Thus, light included in an oscillation region of a pulse laser beam Out output from the optical resonator becomes light linearly polarized in the direction of the H axis. However, light included in an ASE region has not undergone the selection of the specific polarization component due to the light having passed through the windows 10a and 10b a small number of times, resulting in random polarization.

Referring again to FIG. 42, the polarization measuring device 19 includes a beam splitter 19a, a beam compressor 19b, a photosensor 19c, and a polarizer 19d. The beam splitter 19a is located on the optical path of the pulse laser beam Out having been transmitted through the beam splitter 16a. The beam compressor 19b includes a combination of a convex lens and a concave lens, reduces the beam diameter of the pulse laser beam Out reflected by the beam splitter 19a, and causes the pulse laser beam Out to be incident on the polarizer 19d. The polarizer 19d includes, for example, a prism of magnesium fluoride crystal, allowing the polarization component in the direction of the H axis to pass therethrough while suppressing other polarization components. The photosensor 19c is located on the optical path of the light having been transmitted through the polarizer 19d and detects pulse energy POe of the polarization component in the direction of the H axis. Since the light in the ASE region has a small amount of polarization component in the direction of the H axis, it is possible to evaluate the energy of the oscillation region by the pulse energy POe detected by the photosensor 19c. Therefore, the position and the posture of the front mirror 15 are controlled using the pulse energy POe as the evaluation parameter value in the third embodiment.

### 4.2 Operation of Oscillation Region Adjustment

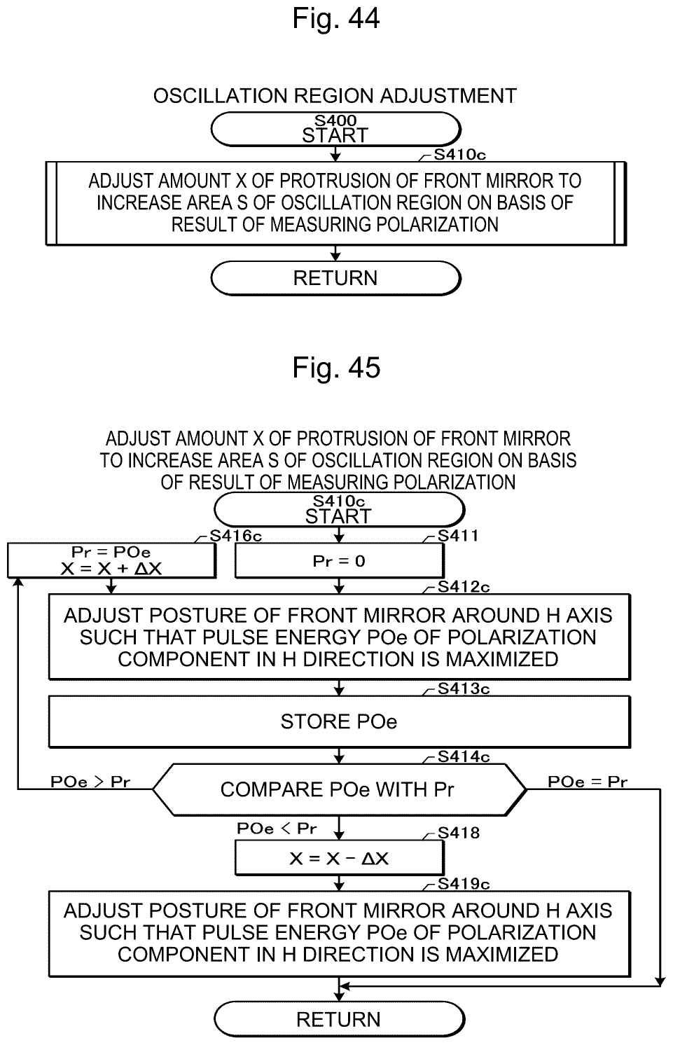

FIG. 44 is a flowchart illustrating details of processing of oscillation region adjustment in the third embodiment. The processing illustrated in FIG. 44 corresponds to a subroutine of S400 illustrated in FIG. 25.

In S410c, the laser control processor 13 adjusts the amount X of protrusion of the front mirror 15 to increase the area S of the oscillation region on the basis of the result of measuring the polarization by the polarization measuring device 19. Details of the processing in S410c will be described later with reference to FIGS. 45 to 48.

After S410c, the laser control processor 13 ends the processing of this flowchart and returns to the processing illustrated in FIG. 25.

### 4.2.1 Oscillation Region Adjustment to Search for Maximum Value of Evaluation Parameter Value

FIG. 45 is a flowchart illustrating details of a first example of the oscillation region adjustment in the third embodiment. The processing illustrated in FIG. 45 corresponds to a subroutine of S410c illustrated in FIG. 44.

The processing illustrated in FIG. 45 is similar to the processing illustrated in FIG. 28 other than that area S of the oscillation region in FIG. 28 is replaced with the pulse energy POe of the polarization component in the direction of the H axis and the beam size BPV in the V direction in FIG. 28 is replaced with the pulse energy POe. Note that “c” is added to ends of step numbers where the above replacement is made.

Through the processing illustrated in FIG. 45, the amount X of protrusion is determined, and the posture of the front mirror 15 is further adjusted around the axis parallel to the H axis, by searching for the maximum value of the pulse energy POe while changing the amount X of protrusion. It is thus possible to increase the ratio of the oscillation region and to reduce the M² value.

### 4.2.2 Oscillation Region Adjustment to Acquire Relationship of Amount X of Protrusion and Evaluation Parameter Value

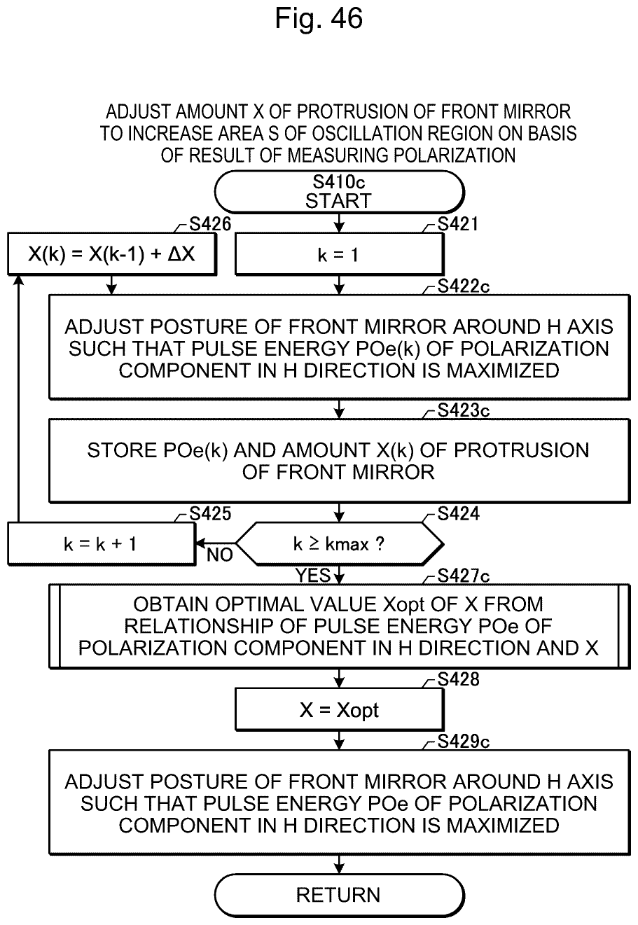

FIG. 46 is a flowchart illustrating details of a second example of the oscillation region adjustment in the third embodiment. The processing illustrated in FIG. 46 corresponds to a subroutine of S410c illustrated in FIG. 44.

The processing illustrated in FIG. 46 is similar to the processing illustrated in FIG. 29 other than that area S of the oscillation region in FIG. 29 is replaced with the pulse energy POe (k) or POe of the polarization component in the direction of the H axis and the beam size BPV (k) and BPV in the V direction in FIG. 29 are replaced with the pulse energy POe (k) and POe. Note that “c” is added to ends of step numbers where the above replacement is made.

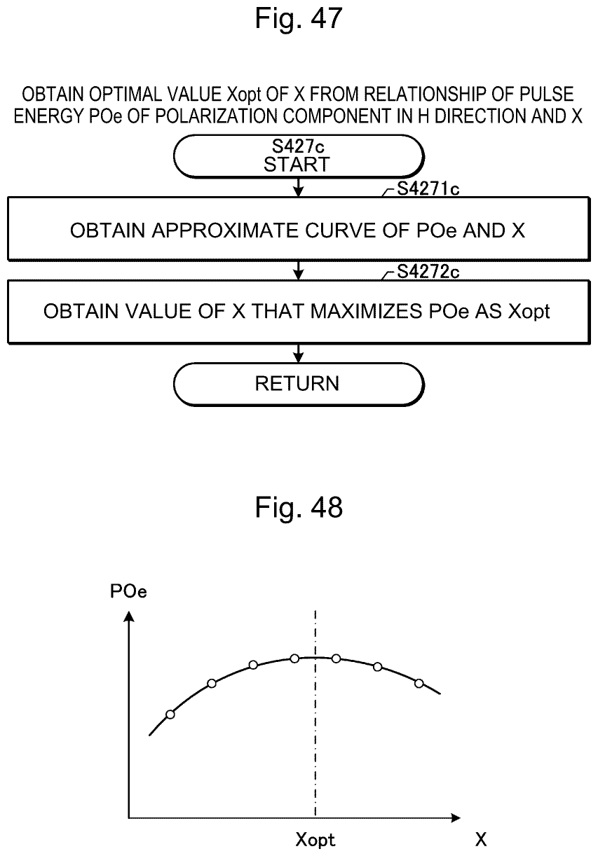

FIG. 47 is a flowchart illustrating details of the processing to obtain the optimal value Xopt of the amount X of protrusion in the third embodiment. The processing illustrated in FIG. 47 corresponds to a subroutine of S427c illustrated in FIG. 46.

In S4271c, the laser control processor 13 obtains an approximate curve indicating the relationship between the amount X of protrusion and the pulse energy POe of the polarization component in the direction of the H axis.

In S4272c, the laser control processor 13 obtains, as the optimal value Xopt, the value of the amount X of protrusion that maximizes the pulse energy POe from the approximate curve.

After S4272c, the laser control processor 13 ends the processing of this flowchart and returns to the processing illustrated in FIG. 46.

FIG. 48 illustrates an example of the approximate curve obtained in FIG. 47. As the amount X of protrusion is increased from the initial value X0, the oscillation region increases and the ASE region decreases, causing the pulse energy POe of the polarization component in the direction of the H axis to gradually increase. However, after there becomes substantially no ASE region, the ASE region does not further decrease even if the amount X of protrusion is increased, a part of the outgoing port of the pulse laser beam Out is rather blocked by the front mirror 15, and the pulse energy POe gradually decreases. It is possible to obtain a large oscillation region by obtaining the amount X of protrusion that maximizes the pulse energy POe.

Through the processing illustrated in FIGS. 46 to 48, the amount X of protrusion that maximizes the pulse energy POe is determined, and the posture of the front mirror 15 is further adjusted around the axis parallel to the H axis, on the basis of the relationships between the amount X of protrusion and the pulse energy POe. It is thus possible to increase the ratio of the oscillation region and to reduce the M² value.

### 4.3 Effect

(12) According to the third embodiment, the beam characteristic measuring device includes the polarization measuring device 19 configured to measure the polarization component in the direction of the H axis perpendicular to the direction of the V axis in the pulse laser beam Out. The laser control processor 13 controls the first and second actuators 151 and 152 using the pulse energy POe of the polarization component as the evaluation parameter value.

According to this, the light of the oscillation region is polarized in the H direction, and it is thus possible to estimate the size of the oscillation region with high precision by measuring the polarization component in the H direction.

In other respects, the third embodiment is similar to the first embodiment.

### 5. Laser Apparatus 1d Using Result of Measurement by Beam Divergence Measuring Device 20 as Evaluation Parameter Value

### 5.1 Configuration

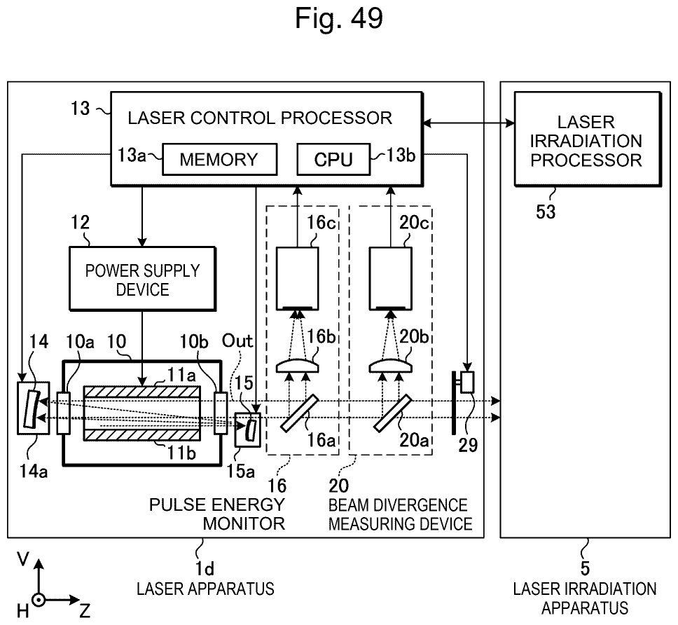

FIG. 49 schematically illustrates a configuration of a laser processing system in a fourth embodiment. In the fourth embodiment, a laser apparatus 1d includes a beam divergence measuring device 20 as a beam characteristic measuring device.

The beam divergence measuring device 20 includes a beam splitter 20a, a light condensing optical system 20b, and an image sensor 20c. The beam splitter 20a is located on the optical path of the pulse laser beam Out having been transmitted through the beam splitter 16a. The light condensing optical system 20b condenses a pulse laser beam Out reflected by the beam splitter 20a. The image sensor 20c is located with its photosensitive surface placed at a rear focal point of the light condensing optical system 20b.

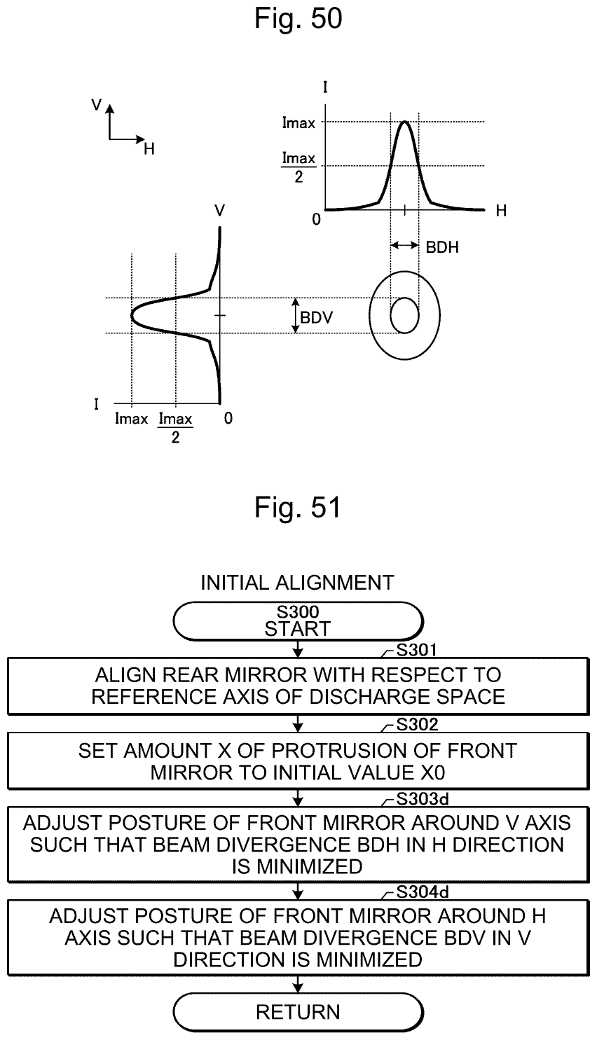

FIG. 50 illustrates an image of a condensed light beam section acquired by the beam divergence measuring device 20, along with its light intensity distribution in the V direction and the H direction. Light in an oscillation region in the pulse laser beam Out is light generated through laser oscillation, the M² value is thus small, the light condensing diameter at the focal point of the light condensing optical system 20b is small, and its peak intensity is high. On the other hand, light in an ASE region contains a large amount of spontaneously released light that has not oscillated, the M² value is thus large, the light condensing diameter at the focal point of the light condensing optical system 20b is large, and its peak intensity is low. Therefore, a light intensity distribution of synthesized light intensity distribution of a small light condensing diameter and a high peak intensity and light intensity distribution of a large light condensing diameter and a low peak intensity is obtained in observation of the pulse laser beam Out including both the oscillation region and the ASE region by the beam divergence measuring device 20. Thus, the laser control processor 13 calculates the evaluation parameter value as follows to evaluate the size of the oscillation region.

The laser control processor 13 calculates pulse energy BDe of the oscillation region as an evaluation parameter value from two-dimensional light intensity distribution acquired by the beam divergence measuring device 20. For example, the pulse energy BDe of the oscillation region is calculated through multiple integrals of a light intensity I in the V direction and the H direction within a region where the light intensity is equal to or greater than ½ a peak value Imax of the light intensity I in the two-dimensional light intensity distribution.

The laser control processor 13 calculates the beam divergences BDV and BDH in the V direction and the H direction as evaluation parameter values from the two-dimensional light intensity distribution acquired by the beam divergence measuring device 20. For example, the beam divergence BDV in the V direction is calculated as the full width of the part of the light intensity distribution in the V direction along the beam center in the H direction where the light intensity is equal to or greater than ½ the peak value Imax of the light intensity I. The beam divergence BDH in the H direction is calculated as the full width of the part of the light intensity distribution in the H direction along the beam center in the V direction where the light intensity is equal to or greater than ½ the peak value Imax of the light intensity I. Alternatively, the beam divergence BDV in the V direction is calculated as the full width of the part of the integrated light intensity distribution in the V direction obtained through the integral of the two-dimensional light intensity distribution in the H direction for each position in the V direction where the integrated light intensity is equal to or greater than ½ the maximum integrated light intensity.

Although the case where the ratio with respect to the peak value Imax or the maximum integrated light intensity to determine the threshold value is set to ½ has been described, the present disclosure is not limited thereto. In a case where it is known that the light intensity in the ASE region is less than 1/e² the peak value Imax of the light intensity of the oscillation region, or in a case where it is known that the integrated light intensity in the ASE region is less than 1/e² the maximum integrated light intensity of the oscillation region, a threshold value may be determined with reference to 1/e². Alternatively, a value such as 5%, 10%, or the like may be used.

### 5.2 Operation of Initial Alignment

FIG. 51 is a flowchart illustrating details of processing of initial alignment in the fourth embodiment. The processing illustrated in FIG. 51 corresponds to a subroutine of S300 illustrated in FIG. 25.

Processing in S301 and S302 is similar to that described with reference to FIG. 26. Instead of S303 in FIG. 26, processing in S303d and S304d is performed in FIG. 51.

In S303d, the laser control processor 13 adjusts the posture of the front mirror 15 around the V axis such that the beam divergence BDH in the direction parallel to the H axis is minimized.

In S304d, the laser control processor 13 adjusts the posture of the front mirror 15 around the H axis such that the beam divergence BDV in the direction parallel to the V axis is minimized.

If the front mirror 15 is misaligned, sufficient laser oscillation is not achieved, and the beam divergences BDH and BDV thus becomes large. It is possible to align the front mirror 15 and to reduce the M² value by adjusting the posture of the front mirror 15 such that each of the beam divergences BDH and BDV is minimized.

After S304d, the laser control processor 13 ends the processing of this flowchart and returns to the processing illustrated in FIG. 25. The order of S303d and S304d may be reversed, and S303d may be performed after S304d.

Furthermore, it is possible to obtain beam pointing, that is, an outgoing direction of the pulse laser beam Out by calculating the position of the center of gravity of the two-dimensional light intensity distribution acquired by the beam divergence measuring device 20. It is also possible to improve precision of beam pointing by adding control to cause the beam pointing to approach a target value in the initial alignment.

### 5.3 Operation of Oscillation Region Adjustment

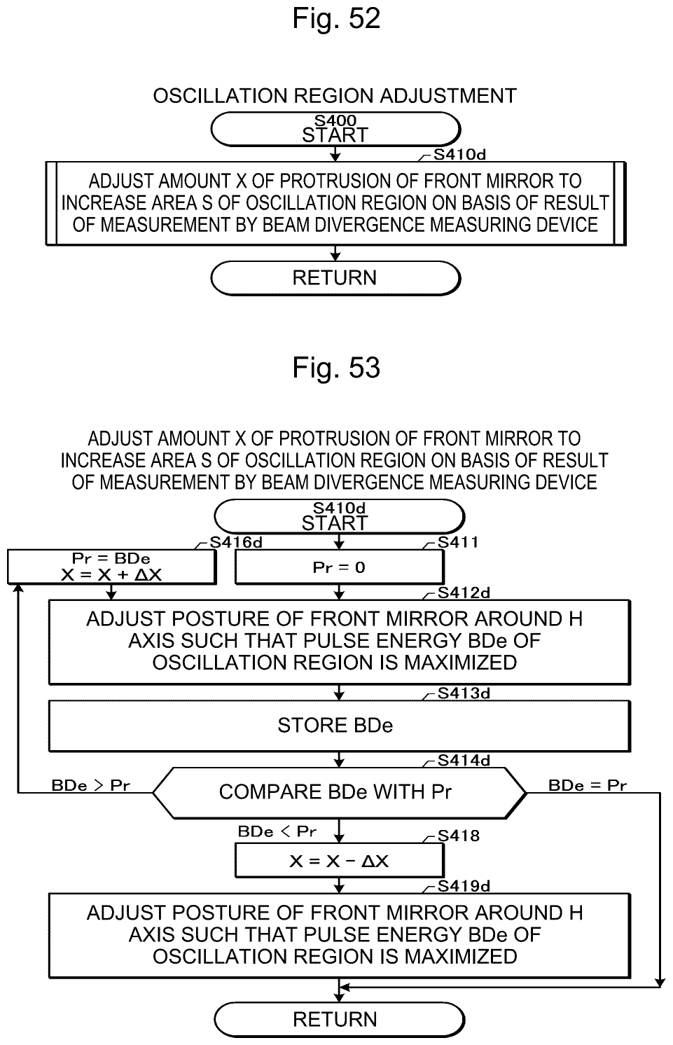

FIG. 52 is a flowchart illustrating details of processing of oscillation region adjustment in the fourth embodiment. The processing illustrated in FIG. 52 corresponds to a subroutine of S400 illustrated in FIG. 25.

In S410d, the laser control processor 13 adjusts the amount X of protrusion of the front mirror 15 to increase the area S of the oscillation region on the basis of the result of measurement by the beam divergence measuring device 20. Details of the processing in S410d will be described later with reference to FIGS. 53 to 60.

After S410d, the laser control processor 13 ends the processing of this flowchart and returns to the processing illustrated in FIG. 25.

### 5.3.1 Oscillation Region Adjustment to Search for Maximum Value of Evaluation Parameter Value

FIG. 53 is a flowchart illustrating details of a first example of oscillation region adjustment in the fourth embodiment. The processing illustrated in FIG. 53 corresponds to a subroutine of S410d illustrated in FIG. 52.

The processing illustrated in FIG. 53 is similar to the processing illustrated in FIG. 28 other than that the area S of the oscillation region in FIG. 28 is replaced with the pulse energy BDe of the oscillation region and the beam size BPV in the V direction in FIG. 28 is replaced with the pulse energy BDe. Note that “d” is added to ends of step numbers where the above replacement is made.

Through the processing illustrated in FIG. 53, the amount X of protrusion is determined, and the posture of the front mirror 15 is further adjusted around the axis parallel to the H axis, by searching for the maximum value of the pulse energy BDe while changing the amount X of protrusion. It is thus possible to increase the ratio of the oscillation region and to reduce the M² value.

### 5.3.2 Oscillation Region Adjustment to Acquire Relationship of Amount X of Protrusion and Evaluation Parameter Value

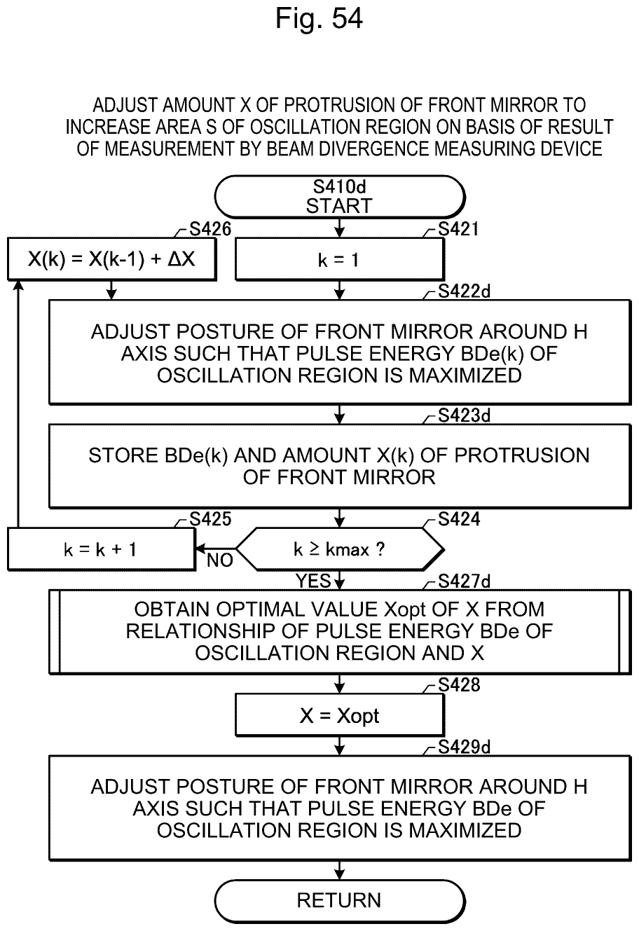

FIG. 54 is a flowchart illustrating details of a second example of the oscillation region adjustment in the fourth embodiment. The processing illustrated in FIG. 54 corresponds to a subroutine of S410d illustrated in FIG. 52.

The processing illustrated in FIG. 54 is similar to the processing illustrated in FIG. 29 other than that the area S of the oscillation region in FIG. 29 is replaced with the pulse energy BDe (k) or BDe of the oscillation region and the beam size BPV (k) and BPV in the V direction in FIG. 29 are replaced with the pulse energy BDe (k) and BDe. Note that “d” is added to ends of step numbers where the above replacement is made.

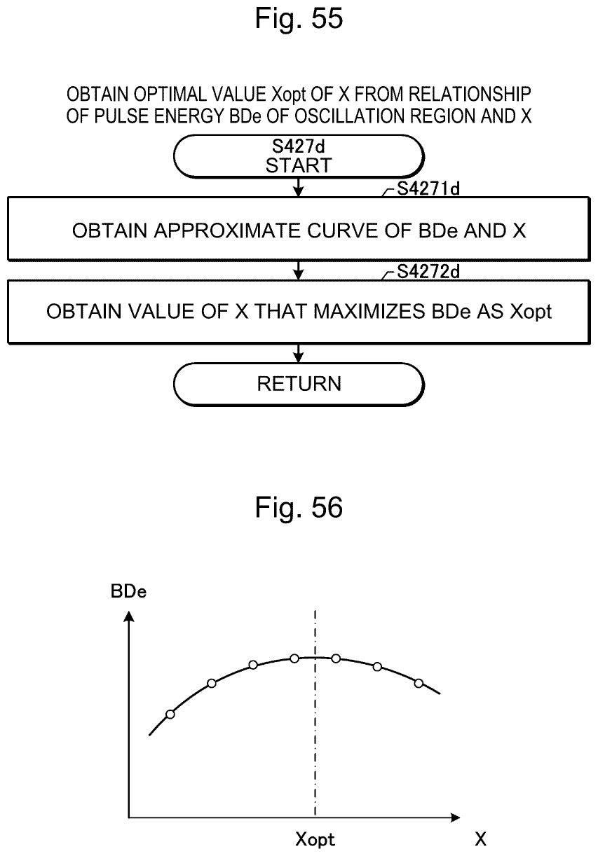

FIG. 55 is a flowchart illustrating details of the processing to obtain the optimal value Xopt of the amount X of protrusion in the second example of the fourth embodiment. The processing illustrated in FIG. 55 corresponds to a subroutine of S427d illustrated in FIG. 54.

In S4271d, the laser control processor 13 obtains an approximate curve indicating the relationship between the amount X of protrusion and the pulse energy BDe of the oscillation region.

In S4272d, the laser control processor 13 obtains, as the optimal value Xopt, the value of the amount X of protrusion that maximizes the pulse energy BDe from the approximate curve.

After S4272d, the laser control processor 13 ends the processing of this flowchart and returns to the processing illustrated in FIG. 54.

FIG. 56 illustrates an example of the approximate curve obtained in FIG. 55. As the amount X of protrusion is increased from the initial value X0, the oscillation region increases and the ASE region decreases, causing the pulse energy BDe of the oscillation region to gradually increase. However, after there becomes substantially no ASE region, the ASE region does not further decrease even if the amount X of protrusion is increased, a part of the outgoing port of the pulse laser beam Out is rather blocked by the front mirror 15, and the pulse energy BDe gradually decreases. It is possible to obtain a large oscillation region by obtaining the amount X of protrusion that maximizes the pulse energy BDe.

Through the processing illustrated in FIGS. 54 to 56, the amount X of protrusion that maximizes the pulse energy BDe is determined, and the posture of the front mirror 15 is further adjusted around the axis parallel to the H axis, on the basis of the relationships between the amount X of protrusion and the pulse energy BDe. It is thus possible to increase the ratio of the oscillation region and to reduce the M² value.

### 5.3.3 Oscillation Region Adjustment to Search for Minimum Value of Beam Divergence BDV

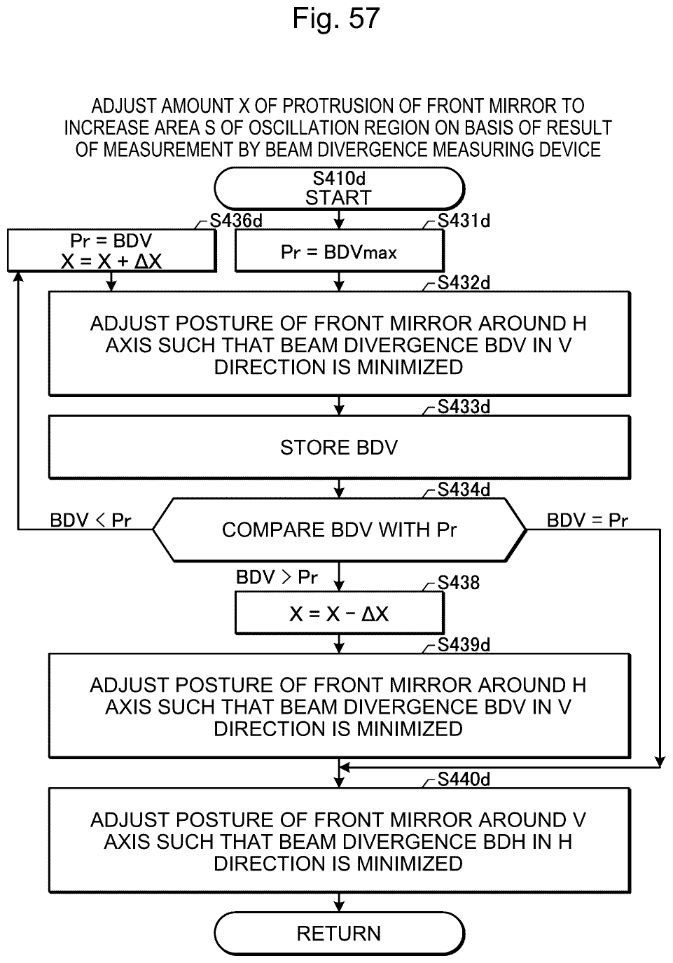

FIG. 57 is a flowchart illustrating details of a third example of the oscillation region adjustment in the fourth embodiment. The processing illustrated in FIG. 57 corresponds to a subroutine of S410d illustrated in FIG. 52.

In S431d, the laser control processor 13 sets the previous value Pr used in S434d to the initial value BDVmax. The initial value BDVmax is set to a value greater than the beam divergence BDV expected when the amount X of protrusion is set to the initial value X0, for example.

In S432d, the laser control processor 13 controls the second actuator 152 to adjust the posture of the front mirror 15 around the axis parallel to the H axis such that the beam divergence BDV in the V direction is minimized.

In S433d, the laser control processor 13 stores the beam divergence BDV in the V direction when the posture of the front mirror 15 is adjusted in S432d.

In S434d, the laser control processor 13 compares the beam divergence BDV in the V direction stored in S433d with the previous value Pr. In a case where the beam divergence BDV is smaller than the previous value Pr (BDV<Pr), the laser control processor 13 moves on to the processing in S436d. In a case where the beam divergence BDV is greater than the previous value Pr (BDV>Pr), the laser control processor 13 moves on to the processing in S438. In a case where the beam divergence BDV is equal to the previous value Pr (BDV=Pr), the laser control processor 13 regards the beam divergence BDV as having reached the minimum value and moves on to the processing in S440d.

In S436d, the laser control processor 13 updates the previous value Pr by setting the previous value Pr to the same value as the beam divergence BDV in the V direction stored in S433d. Furthermore, the laser control processor 13 adds a positive number ΔX to the current amount X of protrusion of the front mirror 15 to update the setting value of the amount X of protrusion, and controls the first actuator 151 in accordance with the new setting value of the amount X of protrusion. After S436d, a change in beam divergence BDV due to the new setting value of the amount X of protrusion is determined by performing the processing in S432d to S434d again.

In S438, the laser control processor 13 regards the amount X of protrusion of the front mirror 15 as having become excessively large, updates the setting value of the amount X of protrusion by subtracting the positive number ΔX from the current amount X of protrusion, and controls the first actuator 151 in accordance with the new setting value of the amount X of protrusion.

After S438, the laser control processor 13 controls the second actuator 152 to adjust the posture of the front mirror 15 around the axis parallel to the H axis such that the beam divergence BDV in the V direction is minimized in S439d. This processing is similar to S432d.

After S439d, the laser control processor 13 moves on to the processing in S440d. In S440d, the laser control processor 13 controls a third actuator 153 to adjust the posture of the front mirror 15 around the axis parallel to the V axis such that the beam divergence BDH in the H direction is minimized. It is possible to reduce the M² value in the H direction through the processing in S440d.

After S440d, the laser control processor 13 ends the processing of this flowchart and returns to the processing illustrated in FIG. 52.

Through the processing illustrated in FIG. 57, the amount X of protrusion is determined, and the posture of the front mirror 15 is further adjusted around the axis parallel to each of the V axis and the H axis, by searching for the minimum value of the beam divergence BDV in the V direction while changing the amount X of protrusion. It is thus possible to increase the ratio of the oscillation region and to reduce the M² value.

### 5.3.4 Oscillation Region Adjustment to Acquire Relationship of Amount X of Protrusion and Beam Divergence BDV

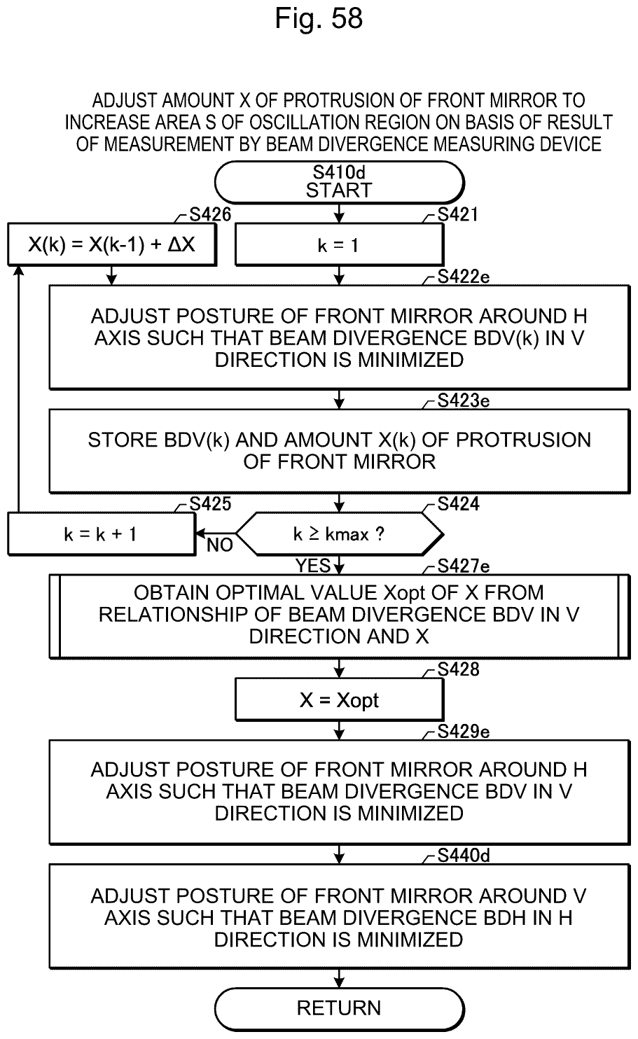

FIG. 58 is a flowchart illustrating details of a fourth example of the oscillation region adjustment in the fourth embodiment. The processing illustrated in FIG. 58 corresponds to a subroutine of S410d illustrated in FIG. 52.

The processing illustrated in FIG. 58 is achieved by replacing the pulse energy BDe (k) and BDe of the oscillation region in FIG. 54 with the beam divergence BDV(k) and BDV in the V direction. Note that “e” is added to ends of step numbers where the above replacement is made.

In S422e and S429e, the laser control processor 13 controls the second actuator 152 to adjust the posture of the front mirror 15 around the axis parallel to the H axis such that each of the beam divergence BDV(k) and BDV in the V direction is minimized.

After S429e, the laser control processor 13 controls the third actuator 153 to adjust the posture of the front mirror 15 around the axis parallel to the V axis such that the beam divergence BDH in the H direction is minimized in S440d.

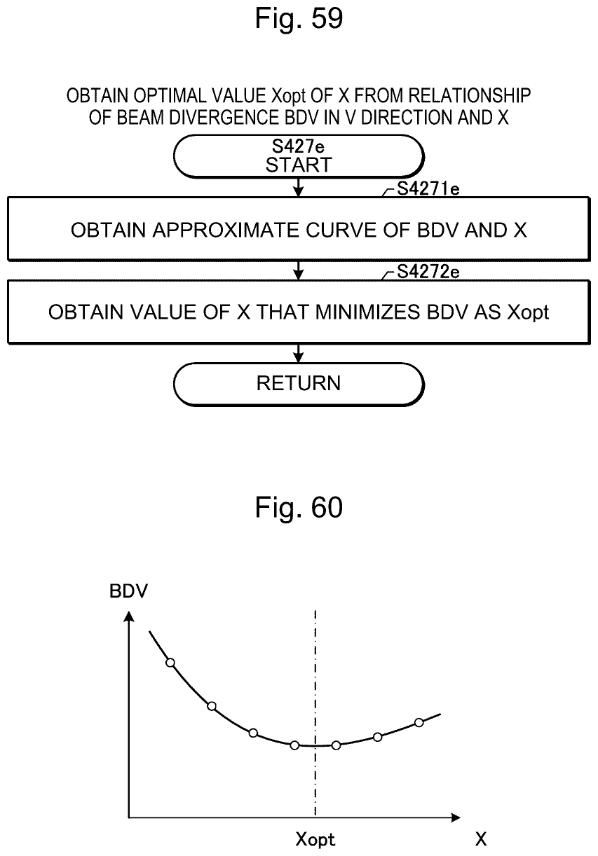

FIG. 59 is a flowchart illustrating details of the processing of obtaining the optimal value Xopt of the amount X of protrusion in the fourth example of the fourth embodiment. The processing illustrated in FIG. 59 corresponds to a subroutine of S427e illustrated in FIG. 58.

In S4271e, the laser control processor 13 obtains an approximate curve indicating the relationship between the amount X of protrusion and the beam divergence BDV in the V direction.

In S4272e, the laser control processor 13 obtains, as the optimal value Xopt, the value of the amount X of protrusion that minimizes the beam divergence BDV from the approximate curve.

After S4272e, the laser control processor 13 ends the processing of this flowchart and returns to the processing illustrated in FIG. 58.

FIG. 60 illustrates an example of the approximate curve obtained in FIG. 59. As the amount X of protrusion is increased from the initial value X0, the oscillation region increases and the ASE region decreases, causing the beam divergence BDV in the V direction to gradually decrease. However, after there becomes substantially no ASE region, the ASE region does not further decrease even if the amount X of protrusion is increased, a part of the outgoing port of the pulse laser beam Out is rather blocked by the front mirror 15, the oscillation region gradually decreases, the number of openings (NA) in the light condensing optical system 20b decreases, and the beam divergence BDV thus increases. It is possible to obtain a large oscillation region by obtaining the amount X of protrusion that minimizes the beam divergence BDV.

Through the processing illustrated in FIGS. 58 to 60, the amount X of protrusion that minimizes the beam divergence BDV is determined, and the posture of the front mirror 15 is further adjusted around the axis parallel to each of the V axis and the H axis, on the basis of the relationship between the amount X of protrusion and the beam divergence BDV. It is thus possible to increase the ratio of the oscillation region and to reduce the Me value.

### 5.4 Effect

(13) According to the fourth embodiment, the beam characteristic measuring device includes the beam divergence measuring device 20 configured to measure the light intensity distribution at the light condensing point of the pulse laser beam Out. The laser control processor 13 controls the first and second actuators 151 and 152 using the pulse energy BDe of the oscillation region obtained from the light intensity distribution as an evaluation parameter value.

According to this, it is possible to determine the position of the front mirror 15 that increases the oscillation region with high precision by obtaining the pulse energy BDe of the oscillation region from the light intensity distribution at the light condensing point.

(14) According to the fourth embodiment, the laser control processor 13 controls the second actuator 152 to reduce the beam divergence BDV and BDH obtained from the light intensity distribution. Subsequently, the laser control processor 13 controls the first and second actuators 151 and 152 using the pulse energy BDe of the oscillation region obtained from the light intensity distribution as an evaluation parameter value.

According to this, it is possible to perform the alignment with the reference axis of the discharge space with high precision by using the beam divergence BDV and BDH and to thereby control the position of the front mirror 15 later to increase the oscillation region with high precision. Furthermore, since the beam divergence BDV and BDH are controlled to become small, it is possible to reduce the M² value in each of the V direction and the H direction.

(15) According to the fourth embodiment, the beam characteristic measuring device includes the beam divergence measuring device 20 configured to measure the light intensity distribution at the light condensing point of the pulse laser beam Out. The laser control processor 13 controls the first and second actuators 151 and 152 using the beam divergence BDV obtained from the light intensity distribution as an evaluation parameter value.

According to this, it is possible to estimate the size of the oscillation region from the beam divergence BDV and to thereby control the position of the front mirror 15 to increase the oscillation region with high precision.

In other respects, the fourth embodiment is similar to the first embodiment.

### 6. Laser Apparatus if Using Partial Beam Characteristic as Evaluation Parameter Value

### 6.1 Configuration

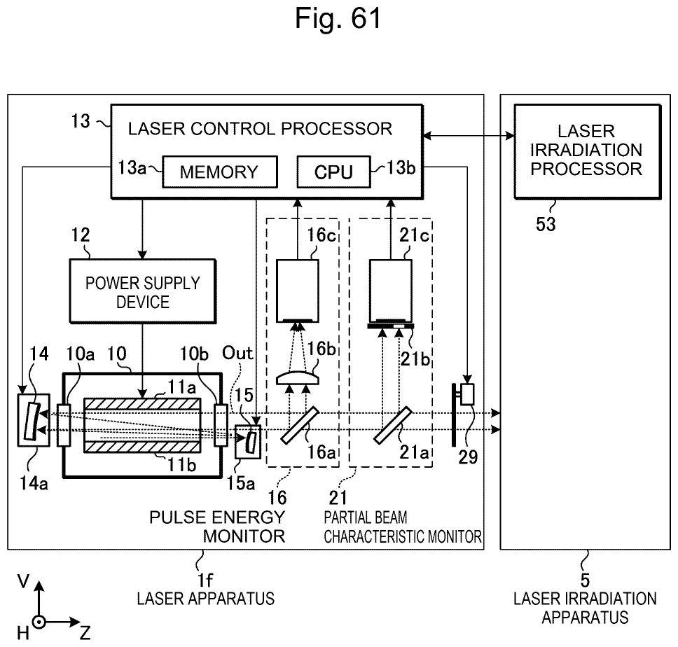

FIG. 61 schematically illustrates a configuration of a laser processing system in a fifth embodiment. In the fifth embodiment, a laser apparatus 1f includes a partial beam characteristic monitor 21 as a beam characteristic measuring device.

The partial beam characteristic monitor 21 includes a beam splitter 21a, a light-shielding plate 21b with an aperture formed therein, and a photosensor 21c. The beam splitter 21a is located on the optical path of the pulse laser beam Out having been transmitted through the beam splitter 16a. The light-shielding plate 21b shields a first part Out1 of the pulse laser beam Out reflected by the beam splitter 21a and allows a second part Out2 to pass through via the aperture (see FIG. 8). The photosensor 21c receives the second part Out2, which is far from the optical axis of the optical resonator of the pulse laser beam Out, to detect the partial beam characteristic of the pulse laser beam Out.

The partial beam characteristic is, for example, pulse energy Ease of the second part Out2. In a case where the pulse laser beam Out contains a large amount of ASE region, a large amount of ASE region is contained in the second part Out2, and the pulse energy Ease of the second part Out2 may thus become a small value. In a case where the pulse laser beam Out contains a large amount of oscillation region, the second part Out2 also contains a large amount of oscillation region, and the pulse energy Ease of the second part Out2 may thus become a large value. Therefore, the pulse energy Ease is calculated as an evaluation parameter value, and the position of the front mirror 15 is controlled to increase the oscillation region in the fifth embodiment.

### 6.2 Operation of Oscillation Region Adjustment

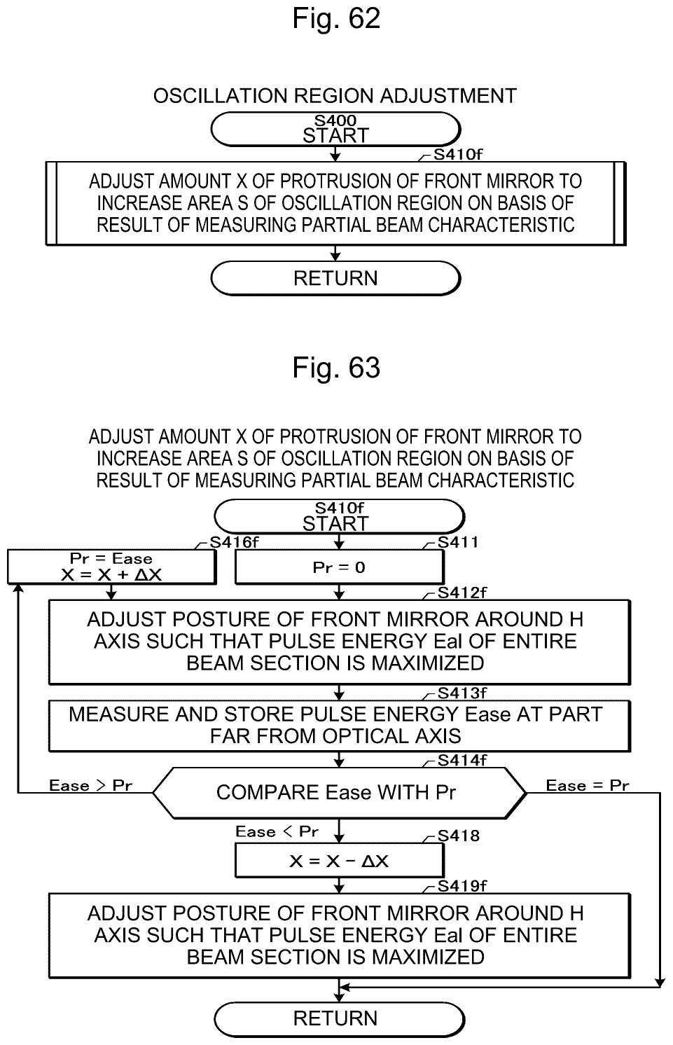

FIG. 62 is a flowchart illustrating details of processing of oscillation region adjustment in the fifth embodiment. The processing illustrated in FIG. 62 corresponds to a subroutine of S400 illustrated in FIG. 25.

In S410f, the laser control processor 13 adjusts the amount X of protrusion of the front mirror 15 to increase the area S of the oscillation region on the basis of the result of measuring the partial beam characteristic by the partial beam characteristic monitor 21. Details of the processing in S410f will be described later with reference to FIGS. 63 to 69.

After S410f, the laser control processor 13 ends the processing of this flowchart and returns to the processing illustrated in FIG. 25.

### 6.2.1 Oscillation Region Adjustment to Search for Maximum Value of Evaluation Parameter Value

FIG. 63 is a flowchart illustrating details of a first example of the oscillation region adjustment in the fifth embodiment. The processing illustrated in FIG. 63 corresponds to a subroutine of S410f illustrated in FIG. 62.

The processing illustrated in FIG. 63 is similar to the processing illustrated in FIG. 28 other than that the area S of the oscillation region in FIG. 28 is replaced with the pulse energy Eal of the entire beam section measured by the pulse energy monitor 16 and the beam size BPV in the V direction in FIG. 28 is replaced with the pulse energy Ease of the second part Out2 far from the optical axis of the optical resonator. Note that “f” is added to ends of step numbers where the above replacement is made.

Through the processing illustrated in FIG. 63, the amount X of protrusion is determined by searching for the maximum value of the pulse energy Ease of the second part Out2 while changing the amount X of protrusion, and the posture of the front mirror 15 is further adjusted around the axis parallel to the H axis on the basis of the pulse energy Eal of the entire beam section. It is thus possible to increase the ratio of the oscillation region and to reduce the M² value.

### 6.2.2 Oscillation Region Adjustment to Acquire Relationship of Amount X of Protrusion and Evaluation Parameter Value

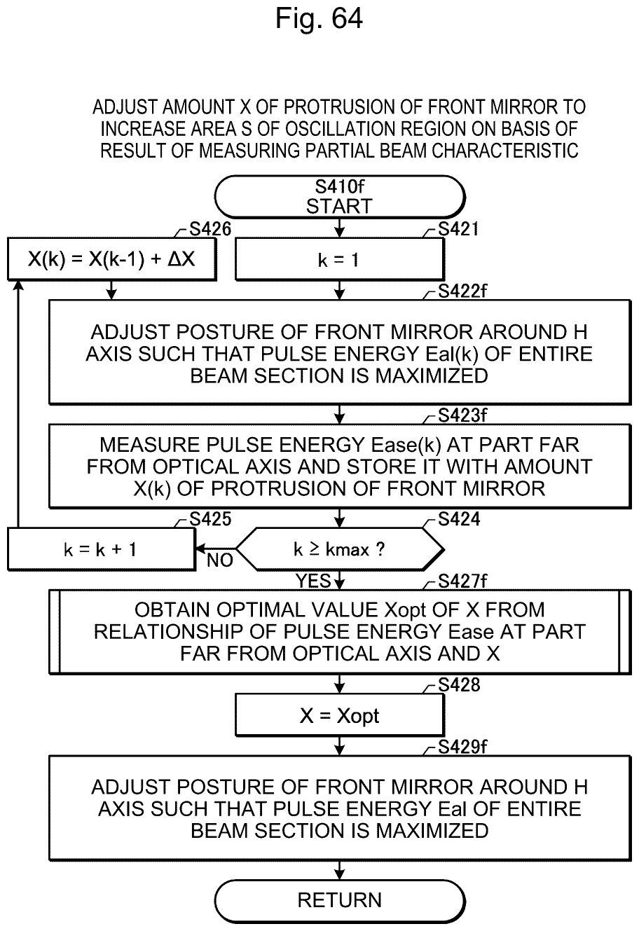

FIG. 64 is a flowchart illustrating details of a second example of the oscillation region adjustment in the fifth embodiment. The processing illustrated in FIG. 64 corresponds to a subroutine of S410f illustrated in FIG. 62.

The processing illustrated in FIG. 64 is similar to the processing illustrated in FIG. 29 other than that the area S of the oscillation region in FIG. 29 is replaced with the pulse energy Eal(k) or Eal of the entire beam section measured by the pulse energy monitor 16 and the beam size BPV (k) and BPV in the V direction in FIG. 29 are replaced with the pulse energy Ease (k) or Ease of the second part Out2 far from the optical axis of the optical resonator. Note that “f” is added to ends of step numbers where the above replacement is made.

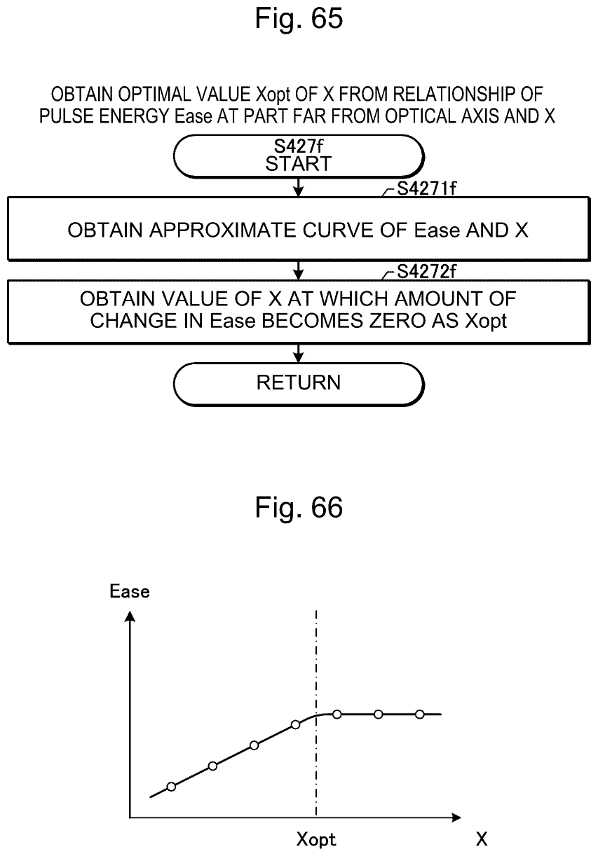

FIG. 65 is a flowchart illustrating details of the processing of obtaining the optimal value Xopt of the amount X of protrusion in the fifth embodiment. The processing illustrated in FIG. 65 corresponds to a subroutine of S427f illustrated in FIG. 64.

In S4271f, the laser control processor 13 obtains an approximate curve indicating the relationship between the amount X of protrusion and the pulse energy Ease of the second part Out2.

In S4272f, the laser control processor 13 obtains, as the optimal value Xopt, the value of the amount X of protrusion at which the amount of change in pulse energy Ease of the second part Out2 becomes zero from the approximate curve.

After S4272f, the laser control processor 13 ends the processing of this flowchart and returns to the processing illustrated in FIG. 64.

FIG. 66 illustrates an example of the approximate curve obtained in FIG. 65. As the amount X of protrusion is increased from the initial value X0, the oscillation region increases and the ASE region decreases, causing the pulse energy Ease of the second part Out2 to gradually increase. However, after there becomes substantially no ASE region, the ASE region does not further decrease even if the amount X of protrusion is increased, substantially the entire second part Out2 becomes the oscillation region, and the amount of change in pulse energy Ease thus becomes zero. It is possible to obtain a large oscillation region by obtaining the amount X of protrusion at which the amount of change in pulse energy Ease becomes zero.

Through the processing illustrated in FIGS. 64 to 66, the amount X of protrusion at which the amount of change in pulse energy Ease becomes zero is determined on the basis of the relationship between the amount X of protrusion and the pulse energy Ease of the second part Out2, and the posture of the front mirror 15 is further adjusted around the axis parallel to the H axis on the basis of the pulse energy Eal of the entire beam section. It is thus possible to increase the ratio of the oscillation region and to reduce the M² value.

### 6.2.3 Oscillation Region Adjustment to Acquire Relationship of Amount X of Protrusion and Plurality of Evaluation Parameter Values

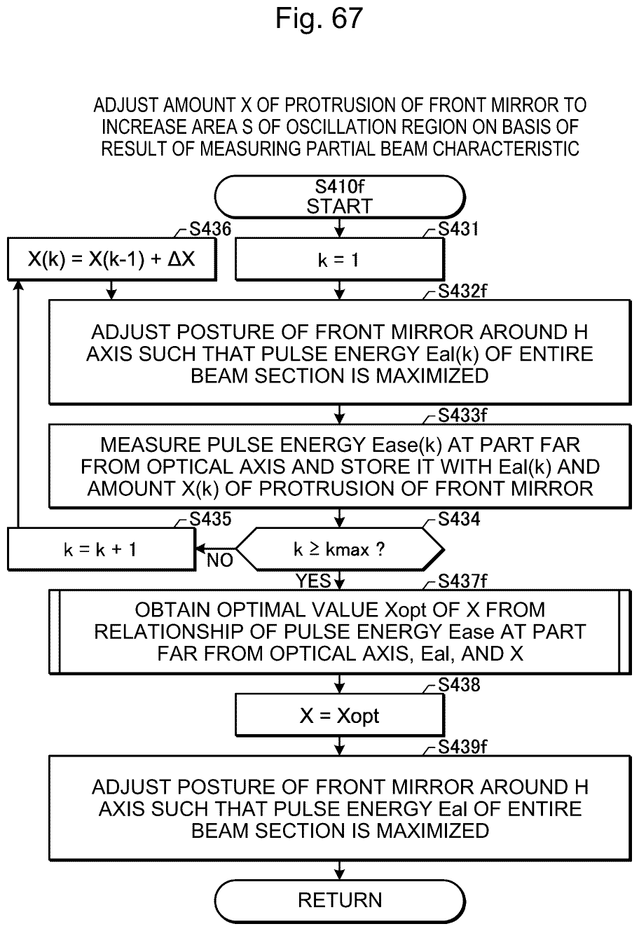

FIG. 67 is a flowchart illustrating details of a third example of the oscillation region adjustment in the fifth embodiment. The processing illustrated in FIG. 67 corresponds to a subroutine of S410f illustrated in FIG. 62.

In FIG. 67, the pulse energy Eal(k) is also stored (S433f) in addition to the storing of the pulse energy Ease (k) of the second part Out2 and the amount X(k) of protrusion in FIG. 64 (S423f). In FIG. 67, the optimal value Xopt of the amount X of protrusion is obtained using not only the relationship between the pulse energy Ease and the amount X of protrusion (S427f) but also the relationship between the pulse energy Eal and the amount X of protrusion (S437f). Note that the step numbers in FIG. 67 have been rewritten by the numbers starting with S43. In other respects, the processing illustrated in FIG. 67 is similar to that in FIG. 64.

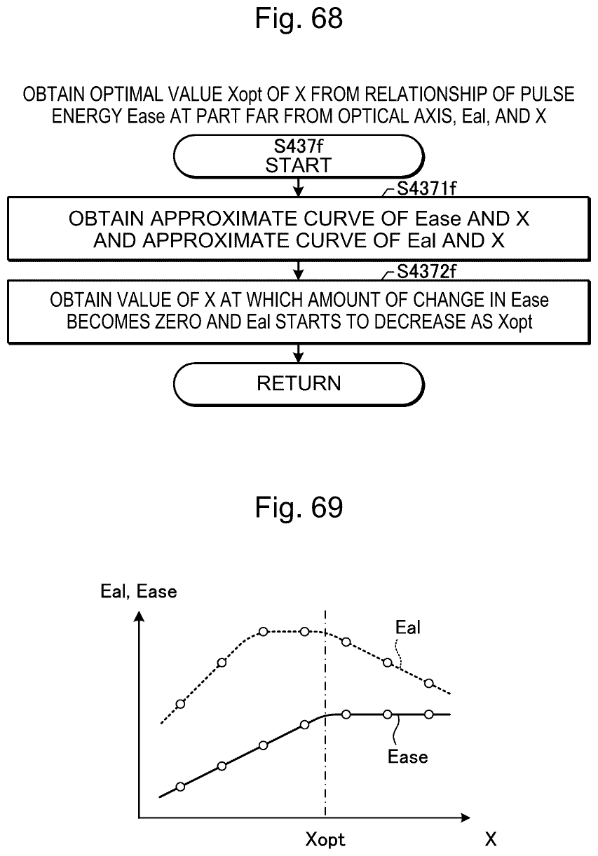

FIG. 68 is a flowchart illustrating details of the processing of obtaining the optimal value Xopt of the amount X of protrusion from a plurality of evaluation parameter values in the fifth embodiment. The processing illustrated in FIG. 68 corresponds to a subroutine of S437f illustrated in FIG. 67.

In S4371f, the laser control processor 13 obtains not only the approximate curve indicating the relationship between the amount X of protrusion and the pulse energy Ease of the second part Out2 but also the approximate curve indicating the relationship between the amount X of protrusion and the pulse energy Eal.

In S4372f, the laser control processor 13 obtains, as the optimal value Xopt, the value of the amount X of protrusion at which the amount of change in pulse energy Ease becomes zero and the pulse energy Eal starts to decrease from the two approximate curves.

After S4372f, the laser control processor 13 ends the processing of this flowchart and returns to the processing illustrated in FIG. 67.

FIG. 69 illustrates examples of the two approximate curves obtained in FIG. 68. As the amount X of protrusion is increased from the initial value X0, the oscillation region increases and the ASE region decreases, causing the pulse energy Eal to gradually increase. However, although the ratio of the oscillation region increases due to a further decrease in the ASE region with the increase in the amount X of protrusion, the size of the oscillation region hits its peak, and the change in pulse energy Eal becomes slow. After there becomes substantially no ASE region, the ASE region does not further decrease even if the amount X of protrusion is increased, a part of the outgoing port of the pulse laser beam Out is rather blocked by the front mirror 15, and the pulse energy Eal decreases. Therefore, the amount X of protrusion at which the amount of change in pulse energy Ease of the second part Out2 becomes zero and the pulse energy Eal starts to decrease is obtained. For example, the amount X of protrusion at which a value obtained by adding products of the pulse energy Ease and the pulse energy Eal multiplied by their weighting coefficients becomes a peak may be defined as the optimal value Xopt.

Through the processing illustrated in FIGS. 67 to 69, the amount X of protrusion is determined, and the posture of the front mirror 15 is further adjusted around the axis parallel to the H axis, on the basis of the relationships between the amount X of protrusion and the pulse energy Ease and between the amount X of protrusion and the pulse energy Eal. It is thus possible to increase the ratio of the oscillation region and to reduce the M² value.

### 6.3 Effect

(16) According to the fifth embodiment, the beam characteristic measuring device includes the partial beam characteristic monitor 21 configured to measure the partial beam characteristic of the second part Out2 of the beam section of the pulse laser beam Out far from the optical axis of the optical resonator. The laser control processor 13 controls the first actuator 151 using the partial beam characteristic as the evaluation parameter value.

According to this, it is possible to control the position of the front mirror 15 to increase the oscillation region with high precision by measuring the partial beam characteristic of the part where the ASE region is likely to be generated.

(17) According to the fifth embodiment, the pulse energy monitor 16 configured to measure the pulse energy Eal of the entire beam section of the pulse laser beam Out is included. The laser control processor 13 controls the first actuator 151 using the partial beam characteristic as the evaluation parameter value and controls the second actuator 152 on the basis of the pulse energy Eal.

According to this, it is possible to appropriately control the posture of the front mirror 15 by using the pulse energy Eal of the entire beam section.

(18) According to the fifth embodiment, the pulse energy monitor 16 configured to measure the pulse energy Eal of the entire beam section of the pulse laser beam Out is included. The laser control processor 13 controls the first actuator 151 on the basis of both the partial beam characteristic and the pulse energy Eal.

While the pulse energy Eal may be large even if the amount X of protrusion of the front mirror 15 is smaller than the optimal value, the partial beam characteristic hardly changes if the amount X of protrusion is larger than the optimal value. It is possible to improve precision by taking both the pulse energy Eal and the partial beam characteristic into consideration.

In other respects, the fifth embodiment is similar to the first embodiment. Although the case where the pulse energy Ease of the second part Out2 is used as the partial beam characteristic has been described in the fifth embodiment, the present disclosure is not limited thereto. The pulse time waveform of the second part Out2, the beam divergence of the second part Out2, the polarization state of the second part Out2, or the like may also be used.

### 7. Others

### 7.1 Electronic Device Including Interposer IP

FIG. 70 schematically illustrates a configuration of an electronic device. The electronic device illustrated in FIG. 70 includes an integrated circuit chip IC, an interposer IP, and a circuit substrate CS.

The integrated circuit chip IC is, for example, a chip in which an unillustrated integrated circuit is formed on a silicon substrate. The integrated circuit chip IC is provided with a plurality of bumps ICB electrically connected to the integrated circuit.

The interposer IP includes an insulating substrate in which a plurality of unillustrated through-holes are formed, and an unillustrated conductor that electrically connects front and back surfaces of the substrate is provided in each of the through-holes. A plurality of unillustrated lands connected to the bumps ICB, respectively, are formed on one surface of the interposer IP, and each of the lands is electrically connected to any one of the conductors in the through-holes. A plurality of bumps IPB are provided on the other surface of the interposer IP, and each of the bumps IPB is electrically connected to any of the conductors in the through-holes.

A plurality of unillustrated lands connected to the bumps IPB, respectively, are formed on one surface of the circuit substrate CS. The circuit substrate CS includes a plurality of terminals electrically connected to the lands, respectively.

FIG. 71 is a flowchart illustrating an electronic device manufacturing method.

In S1, laser processing and wiring formation of the interposer substrate configuring the interposer IP are performed. The laser processing of the interposer substrate includes forming through-holes by irradiating the interposer substrate with the pulse laser beam Out. The wiring formation includes formation of a conductive film on inner wall surfaces of the through-holes formed in the interposer substrate. Through such processes, the interposer IP is created.

In S2, the interposer IP and the integrated circuit chip IC are coupled. This process includes, for example, disposing the bumps ICB of the integrated circuit chip IC on the lands of the interposer IP and electrically connecting the bumps ICB to the lands.

In S3, the interposer IP and the circuit substrate CS are coupled. This process includes, for example, disposing the bumps IPB of the interposer IP on the lands of the circuit substrate CS and electrically connecting the bumps IPB to the lands.

### 7.2 Supplement

The description above is intended to be illustrative and the present disclosure is not limited thereto. Therefore, it would be obvious to those skilled in the art that various modifications to the embodiments of the present disclosure would be possible without departing from the spirit and the scope of the claims. Furthermore, it would be also obvious to those skilled in the art that the embodiments of the present disclosure would be used in combination.

The terms used throughout the present specification and the claims should be interpreted as non-limiting terms, unless otherwise stated. For example, terms such as “comprise”, “include”, “have”, and “contain” should not be interpreted to be exclusive of other structural elements. Further, indefinite articles “a/an” should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A discharge excitation laser apparatus comprising:
a laser chamber that includes a pair of discharge electrodes disposed therein;
an optical resonator that includes a cylindrical convex mirror and a cylindrical concave mirror and is configured to form an off-axis optical path along a first plane that is parallel to a discharge direction of discharge between the discharge electrodes and a longitudinal direction of the discharge electrodes intersecting the discharge direction;
a mirror stage that includes a first actuator configured to move the cylindrical convex mirror in the discharge direction and a second actuator configured to rotate the cylindrical convex mirror about an axis intersecting the first plane;
a beam characteristic measuring device configured to measure a beam characteristic of a laser beam output from the optical resonator; and
a processor configured to control the first and second actuators to increase an oscillation region of the laser beam on the basis of an evaluation parameter value related to the oscillation region obtained from the beam characteristic.

2. The discharge excitation laser apparatus according to claim 1,
wherein the processor
controls the first and second actuators to align the cylindrical convex mirror with respect to a reference axis of a discharge space between the discharge electrodes, and
then controls the first and second actuators on the basis of the evaluation parameter value.

3. The discharge excitation laser apparatus according to claim 1,
wherein the processor
acquires the evaluation parameter value corresponding to an improved oscillation region, which is the oscillation region when the second actuator is controlled such that an alignment parameter value of the optical resonator obtained from the beam characteristic is improved, in each of states where the cylindrical convex mirror is moved to a plurality of positions by the first actuator, and
determines a position of the cylindrical convex mirror that maximizes a size of the improved oscillation region from among the positions.

4. The discharge excitation laser apparatus according to claim 1,
wherein the processor determines, on the basis of a relationship of
a position of the cylindrical convex mirror moved by the first actuator, and
the evaluation parameter value corresponding to an improved oscillation region, which is the oscillation region when the second actuator is controlled such that an alignment parameter value of the optical resonator obtained from the beam characteristic in a state where
the cylindrical convex mirror is moved to the position is improved,
the position of the cylindrical convex mirror controlled by the first actuator.

5. The discharge excitation laser apparatus according to claim 1,
wherein the processor
determines a position of the cylindrical convex mirror controlled by the first actuator on the basis of the evaluation parameter value, and
then controls the second actuator on the basis of an alignment parameter value of the optical resonator obtained from the beam characteristic when the cylindrical convex mirror is disposed at the determined position.

6. The discharge excitation laser apparatus according to claim 1,
wherein the beam characteristic measuring device measures any of
light intensity distribution along a beam section of the laser beam,
a pulse time waveform of the laser beam,
a polarization component of the laser beam in a polarization direction perpendicular to the discharge direction,
light intensity distribution at a light condensing point of the laser beam, and
a partial beam characteristic of a part of the beam section of the laser beam far from an optical axis of the optical resonator.

7. The discharge excitation laser apparatus according to claim 1,
wherein the beam characteristic measuring device is a beam profiler configured to measure light intensity distribution along a beam section of the laser beam, and
the processor controls the first actuator using a width of integrated light intensity distribution, which is obtained by integrating the light intensity distribution in a direction intersecting the discharge direction, in the discharge direction as the evaluation parameter value.

8. The discharge excitation laser apparatus according to claim 1,
wherein the beam characteristic measuring device is a beam profiler configured to measure light intensity distribution along a beam section of the laser beam, and
the processor controls the second actuator on the basis of area of a region having a light intensity of equal to or greater than a predetermined proportion with respect to a peak value of the light intensity distribution.

9. The discharge excitation laser apparatus according to claim 1,
wherein the beam characteristic measuring device is a pulse time waveform measuring device configured to measure a pulse time waveform of the laser beam, and
the processor controls the first and second actuators using a pulse time width obtained from the pulse time waveform as the evaluation parameter value.

10. The discharge excitation laser apparatus according to claim 1, further comprising:
a pulse energy monitor configured to measure pulse energy of the laser beam,
wherein the beam characteristic measuring device is a pulse time waveform measuring device configured to measure a pulse time waveform of the laser beam, and
the processor
controls the first actuator using a pulse time width obtained from the pulse time waveform as the evaluation parameter value, and
controls the second actuator on the basis of the pulse energy.

11. The discharge excitation laser apparatus according to claim 10,
wherein the processor controls the first actuator on the basis of both the pulse time width and the pulse energy.

12. The discharge excitation laser apparatus according to claim 1,
wherein the beam characteristic measuring device is a polarization measuring device configured to measure a polarization component in a polarization direction perpendicular to the discharge direction in the laser beam, and
the processor controls the first and second actuators using pulse energy of the polarization component as the evaluation parameter value.

13. The discharge excitation laser apparatus according to claim 1,
wherein the beam characteristic measuring device is a beam divergence measuring device configured to measure light intensity distribution at a light condensing point of the laser beam, and
the processor controls the first and second actuators using pulse energy of the oscillation region obtained from the light intensity distribution as the evaluation parameter value.

14. The discharge excitation laser apparatus according to claim 13,
wherein the processor
controls the second actuator to reduce beam divergence obtained from the light intensity distribution, and
then controls the first and second actuators using the pulse energy of the oscillation region obtained from the light intensity distribution as the evaluation parameter value.

15. The discharge excitation laser apparatus according to claim 1,
wherein the beam characteristic measuring device is a beam divergence measuring device configured to measure light intensity distribution at a light condensing point of the laser beam, and
the processor controls the first and second actuators using beam divergence obtained from the light intensity distribution as the evaluation parameter value.

16. The discharge excitation laser apparatus according to claim 1,
wherein the beam characteristic measuring device is a partial beam characteristic monitor configured to measure a partial beam characteristic of a part of a beam section of the laser beam far from an optical axis of the optical resonator, and
the processor controls the first actuator using the partial beam characteristic as the evaluation parameter value.

17. The discharge excitation laser apparatus according to claim 16, further comprising:
a pulse energy monitor configured to measure pulse energy of an entire beam section of the laser beam,
wherein the processor
controls the first actuator using the partial beam characteristic as the evaluation parameter value, and
controls the second actuator on the basis of the pulse energy.

18. The discharge excitation laser apparatus according to claim 16, further comprising:
a pulse energy monitor configured to measure pulse energy of an entire beam section of the laser beam, and
the processor controls the first actuator on the basis of both the partial beam characteristic and the pulse energy.

19. A discharge excitation laser apparatus control method of a discharge excitation laser apparatus including a laser chamber that includes a pair of discharge electrodes disposed therein,
an optical resonator that includes a cylindrical convex mirror and a cylindrical concave mirror and is configured to form an off-axis optical path along a first plane that is parallel to a discharge direction of discharge between the discharge electrodes and a longitudinal direction of the discharge electrodes intersecting the discharge direction,
a mirror stage that includes a first actuator configured to move the cylindrical convex mirror in the discharge direction and a second actuator configured to rotate the cylindrical convex mirror about an axis intersecting the first plane, and
a beam characteristic measuring device configured to measure a beam characteristic of a laser beam output from the optical resonator,
the method comprising:
measuring the beam characteristic by the beam characteristic measuring device; and
controlling the first and second actuators to increase an oscillation region of the laser beam on the basis of an evaluation parameter value related to the oscillation region obtained from the beam characteristic.

20. An electronic device manufacturing method, comprising:
creating an interposer by laser-processing an interposer substrate with a discharge excitation laser apparatus including
a laser chamber that includes a pair of discharge electrodes disposed therein,
an optical resonator that includes a cylindrical convex mirror and a cylindrical concave mirror and is configured to form an off-axis optical path along a first plane that is parallel to a discharge direction of discharge between the discharge electrodes and a longitudinal direction of the discharge electrodes intersecting the discharge direction,
a mirror stage that includes a first actuator configured to move the cylindrical convex mirror in the discharge direction and a second actuator configured to rotate the cylindrical convex mirror about an axis intersecting the first plane,
a beam characteristic measuring device configured to measure a beam characteristic of a laser beam output from the optical resonator, and
a processor configured to control the first and second actuators to increase an oscillation region of the laser beam on the basis of an evaluation parameter value related to the oscillation region obtained from the beam characteristic;
coupling and electrically connecting the interposer and an integrated circuit chip to each other; and
coupling and electrically connecting the interposer and a circuit substrate to each other.
